(19) United States
(12) Patent Application Publication
(10) Pub. No.: US 2018/0321532 A1
(43) Pub. Date: Nov. 8, 2018

(54) LAMINATE AND LIQUID CRYSTAL DISPLAY DEVICE

(71) Applicant: FUJIFILM Corporation, Tokyo (JP)

(72) Inventors: Yasuyuki SASADA, Kanagawa (JP); Shuhei OKUDA, Kanagawa (JP)

(73) Assignee: FUJIFILM Corporation, Tokyo (JP)

(21) Appl. No.: 16/039,725

(22) Filed: Jul. 19, 2018

Related U.S. Application Data
(63) Continuation of application No. PCT/JP2017/001807, filed on Jan. 19, 2017.

(30) Foreign Application Priority Data
Feb. 5, 2016 (JP) 2016-020717
May 31, 2016 (JP) 2016-108701
Dec. 26, 2016 (JP) 2016-250983

(51) Int. Cl. G02F 1/13363; B32B 27/18; B32B 7/12; B32B 27/30; G02F 1/1335

(52) U.S. Cl. CPC G02F 1/13363; G02F 1/134363; B32B 7/12; B32B 27/302; G02F 1/133528; B32B 2307/746; B32B 2307/42; B32B 2457/202; B32B 2307/732; B32B 2307/412; B32B 2307/726; G02F 2202/28; G02F 2201/54; G02F 2202/22; B32B 27/18

(57) ABSTRACT

Provided are a laminate including at least: a polarizing layer, an adhesive layer, a transparent layer, and a layer which contains an antistatic agent in this order, in which a thickness of the transparent layer is in a range of 0.1 to 5 μm, and a transition ratio of the antistatic agent after high temperature and high humidity test is in a range of 0% to 30%; and a liquid crystal display device including the laminate.

### CROSS REFERENCE TO RELATED APPLICATION

This is a continuation of International Application No. PCT/JP2017/001807 filed on Jan. 19, 2017, and claims priority from Japanese Patent Application No. 2016-020717 filed on Feb. 5, 2016, Japanese Patent Application No. 2016-108701 filed on May 31, 2016 and Japanese Patent Application No. 2016-250983 filed on Dec. 26, 2016, the entire disclosures of which are incorporated herein by reference.

### BACKGROUND OF THE INVENTION

### 1. Field of the Invention

The present invention relates to a laminate including a polarizing layer and a liquid crystal display device.

### 2. Description of the Related Art

A polarizing plate is an indispensable member constituting a liquid crystal display device. A typical polarizing plate has a configuration in which an optical film is allowed to adhere to one or both surfaces of a polarizing film formed by adsorbing and aligning a dichroic dye such as an iodine complex on a polyvinyl alcohol (PVA)-based resin.

In recent years, since a decrease in thickness and an increase in size of a liquid crystal display device have been progressing rapidly, a problem of occurrence of light unevenness on a display surface of a liquid crystal display device which is accompanied by environmental change has been apparent.

A decrease in thickness and an increase in size have been progressing even in a case of a polarizing plate serving as an indispensable member of a liquid crystal display device so display failure of a panel is likely to be caused by deformation of a polarizing plate. Specifically, light unevenness is considered to occur because a liquid crystal panel adhered to a polarizing plate is warped, and apart from this, a backlight member or the like is deformed so that the panel and the backlight member are brought into contact with each other in a case where the polarizing plate stretches and contracts.

In order to solve this problem, a system (JP2009-122663A) of using an optical film formed of an acrylic resin having a small photoelastic coefficient has been suggested.

Further, a phase difference film which contains an acrylic resin and a styrene-based resin and has a small photoelastic coefficient and a large retardation and a polarizing plate (JP2008-146003A) and a phase difference film (JP2008-185659A) which contains a styrene-based resin and has a large retardation have been suggested.

In addition, a pressure sensitive adhesive (JP2011-504537A) which is used for adhesion between a polarizing plate and a glass substrate, is effective for suppression of failure of a liquid crystal panel due to static electricity, and has antistatic properties has been suggested.

### SUMMARY OF THE INVENTION

As the result of examination, it was understood that, since the acrylic film disclosed in JP2009-122663A and the acrylic styrene-based film disclosed in JP2008-146003A have insufficient adhesiveness to a polarizing layer (also referred to as a “polarizing film” or a “polarizer”) and peeling or cracking occurs in an end surface of a polarizing plate during processing, scraps are likely to be generated from the end surface of the processed polarizing plate and production suitability is degraded.

The styrene-based film disclosed in JP2008-185659A has a low brittleness, and thus it is necessary to increase the film thickness in order to ensure the film hardness. Therefore, it was understood that the retardation is unlikely to be decreased and this results in deterioration of display performance.

Further, it was understood that a laminate formed by bringing a pressure sensitive adhesive composition containing an antistatic agent, disclosed in JP2011-504537A, into direct contact with a polarizing film has excellent performance of suppressing light unevenness of a liquid crystal display device accompanied by environmental change, but the variation in polarization degree is large in a case where the laminate is stored in a high temperature and high humidity environment and the reliability is poor.

An object of the present invention is to provide a laminate, with a high yield, which has excellent reliability and is capable of suppressing light unevenness of a liquid crystal display device which is accompanied by environmental change in a case of being mounted on the liquid crystal display device.

It was found that the above-described problem can be solved by disposing a transparent layer which has a specific thickness and contains an antistatic agent with a low permeability coefficient between a polarizing layer and a layer containing an antistatic agent in order to improve the reliability of the laminate, thereby completing the present invention.

In order to decrease the permeability coefficient of the antistatic agent contained in the transparent layer, it is preferable that the transparent layer is controlled to have a specific relationship between the equilibrium moisture absorptivity and the moisture permeability thereof and it is effective that the transparent layer is controlled to have a specific equilibrium moisture absorptivity or to have a specific moisture permeability. The reason for this is assumed that the permeability coefficient of the antistatic agent is decreased by controlling a phenomenon in which the antistatic agent is dissolved in the transparent layer or a phenomenon the antistatic agent is diffused in the transparent layer.

In a case where the permeability coefficient of the antistatic agent is decreased in the above-described manner, the hydrophobicity of the transparent layer is increased and this may result in significant degradation of the productivity of the laminate in a case where the polarizing layer and the transparent layer are laminated using an adhesive. By controlling the moisture permeability of the transparent layer to a specific value or greater, improvement of the productivity of the laminate and suppression of the permeability coefficient of the antistatic agent can be both achieved.

Accordingly, the present invention as specific means for solving the above-described problems is as follows.

<1> A laminate comprising at least; a polarizing layer; an adhesive layer; a transparent layer; and a layer which contains an antistatic agent, in this order, in which a thickness of the transparent layer is in a range of 0.1 to 10 μm, and a transition ratio of the antistatic agent after high temperature and high humidity test is in a range of 0% to 30%.

<2> The laminate according to <1>, in which the transition ratio of the antistatic agent after high temperature and high humidity test is in a range of 0.01% to 30%.

<3> The laminate according to <1> or <2>, in which an equilibrium moisture absorptivity of the transparent layer is 2.0% by mass or less.

<4> The laminate according to any one of <1> to <3>, in which a moisture permeability of the transparent layer in terms of 5 μm is in a range of 200 to 5000 g/m²/day.

<5> The laminate according to any one of <1> to <4>, in which the transparent layer contains a fluorine-based compound and/or a silicon-based compound.

<6> The laminate according to any one of <1> to <5>, in which the transparent layer contains a styrene-based resin.

<7> The laminate according to any one of <1> to <6>, in which an in-plane retardation Re of the transparent layer at a wavelength of 590 nm is in a range of 0 to 20 nm, and a thickness direction retardation Rth of the transparent layer at a wavelength of 590 nm is in a range of −25 to 25 nm.

<8> The laminate according to any one of <1> to <7>, in which the transparent layer is formed of two or more layers.

<9> The laminate according to any one of <1> to <8>, in which the antistatic agent contains an organic cationic compound.

<10> The laminate according to any one of <1> to <9>, in which the content of the antistatic agent is in a range of 0.01% to 10% by mass with respect to the content of a composition of a layer containing the antistatic agent.

<11> The laminate according to any one of <1> to <10>, in which the polarizing layer contains an iodine-polyvinyl alcohol complex.

<12> A liquid crystal display device comprising: a liquid crystal cell; and the laminate according to any one of claims 1 to 11.

<13> The liquid crystal display device according to <12>, in which the transparent layer is disposed between the polarizing layer and the liquid crystal cell.

<14> The liquid crystal display device according to <12> or <13>, further comprising: a backlight, in which the laminate is disposed on a backlight side.

<15> The liquid crystal display device according to <12> or <13>, further comprising: a backlight, in which the laminate is disposed on a viewing side.

<16> The liquid crystal display device according to any one of <12> to <15>, in which the liquid crystal cell is of an in-plane switching (IPS) system.

<17> A laminate comprising at least; a polarizing layer; an adhesive layer; a transparent layer; and a layer which contains an antistatic agent, in this order, in which a thickness of the transparent layer is in a range of 0.1 to 10 μm, an equilibrium moisture absorptivity of the transparent layer is 2.0% by mass or less, a moisture permeability of the transparent layer in terms of 5 μm is in a range of 200 to 5000 g/m²/day, and the antistatic agent contains an organic cationic compound.

According to the present invention, it is possible to provide a laminate, with a high yield, which has excellent reliability and is capable of suppressing light unevenness of a liquid crystal display device which is accompanied by environmental change in a case of being mounted on the liquid crystal display device. Further, it is possible to provide a liquid crystal display device, with a high yield, which is obtained by using this laminate, is unlikely to generate light unevenness, and has excellent reliability.

### DESCRIPTION OF THE PREFERRED EMBODIMENTS

The contents of the present invention will be described in detail. The description of the constituent elements below will be made based on representative embodiments of the present invention, but the present invention is not limited thereto.

In addition, “(meth)acrylate” indicates at least one of acrylate or methacrylate, “(meth)acryl” indicates at least one of acryl or methacryl, and “(meth)acryloyl” indicates at least one of acryloyl or methacryloyl.

(Transparent Layer)

In a transparent layer, the total light transmittance of visible light (wavelength of 380 to 780 nm) is preferably 80% or greater, more preferably 85% or greater, and still more preferably 90% or greater.

<Transition Ratio of Antistatic Agent after High Temperature and High Humidity Test>

The transition ratio of the antistatic agent after high temperature and high humidity test contained in a layer that contains the antistatic agent of the present invention can be calculated in the following manner. A test piece formed by bringing non-alkali glass having a thickness of 1 mm into close contact with a surface side of the layer, which contains the antistatic agent of a laminate of the present disclosure, on the opposite side of the transparent layer is prepared, held in an environment at a temperature of 85° C. and a relative humidity of 85% for 3 days, and then held in an environment at a temperature of 25° C. and a relative humidity of 60% for 24 hours. Thereafter, the laminate is taken out to prepare a section piece sample of the laminate using a microtome. Next, the section profile of the amount of the antistatic agent of the section piece sample is measured using TOF-SIMS, and a ratio (A2/A1×100) between an integrated value (A2) of the amount of the antistatic agent transitioned closer to a polarizing film side than the transparent layer of the present invention and an integrated value (A1) of the layer containing the antistatic agent can be calculated. Further, the antistatic agent and the layer containing the antistatic agent are extracted using a solvent that swells or dissolves the antistatic agent and the layer, and a ratio (B2/B1×100) between the an amount (B2) of the extracted antistatic agent and an amount (B1) of the antistatic agent before a moisture-heat treatment can be calculated. In the present invention, the value obtained by performing calculation using the former method between the above-described calculation methods is set as a transition ratio after high temperature and high humidity test.

The transition ratio of the antistatic agent of the present invention is in a range of 0% to 30%, preferably in a range of 0.01% to 30%, more preferably in a range of 0.1% to 25%, and still more preferably in a range of 0.5% to 20%. In a case where the transition ratio is in the above-described range, both of the durability of the polarizing layer and the adhesiveness between the polarizing layer and the transparent layer can be achieved. In order to ensure the transition ratio of the antistatic agent after high temperature and high humidity test and the adhesiveness between the polarizing layer and the transparent layer, it is effective to control the relationship between the equilibrium moisture absorptivity of the transparent layer and the value obtained by dividing the moisture permeability by the equilibrium moisture absorptivity.

<Equilibrium Moisture Absorptivity>

Since the equilibrium moisture absorptivity of the transparent layer according to the present invention controls the permeability coefficient of the antistatic agent, the equilibrium moisture absorptivity at a temperature of 25° C. and a relative humidity of 80% is preferably in a range of 0% to 2.0% by mass, regardless of the thickness. Further, the equilibrium moisture absorptivity is more preferably in a range of 0% to 1.0% by mass and still more preferably in a range of 0.01% to 0.5% by mass. From the viewpoint of suppressing the phenomenon in which the antistatic agent is dissolved in the transparent layer, the equilibrium moisture absorptivity is preferably 2.0% by mass or less.

In the present specification, the equilibrium moisture absorptivity of the transparent layer can be measured using a sample whose thickness is increased as necessary. The equilibrium moisture absorptivity can be acquired by adjusting the humidity of the sample for 24 hours, performing measurement using a moisture measuring device “CA-03” and a sample drying device “VA-05” (both manufactured by Mitsubishi Chemical Corporation) according to a Karl Fischer method, and performing calculation by dividing the moisture content (g) by the mass (g) of the sample.

<Moisture Permeability>

The moisture permeability of the transparent layer according to the present invention is measured in conformity with JIS Z-0208 under conditions of 40° C. at a relative humidity of 90%. In the present specification, the moisture permeability of the transparent layer can be measured using a film whose thickness is increased such that the self-supporting properties can be maintained as necessary. The value calculated by dividing the obtained moisture permeability by the thickness (unit: μm) of the film used for the measurement and multiplying the obtained value by 5 is set as the moisture permeability in terms of 5 μm.

The moisture permeability of the transparent layer according to the present invention is not particularly limited, but the moisture permeability in terms of 5 μm is preferably in a range of 200 to 5000 g/m²/day. The moisture permeability in terms of 5 m is more preferably in a range of 500 to 3000 g/m²/day and particularly preferably in a range of 700 to 2000 g/m²/day. It is preferable that the moisture permeability is in the above-described range from the viewpoint that both of the polarizing plate processability and the durability of the polarizing plate with respect to the humidity or moisture heat can be achieved.

Further, in a case where such a film whose self-supporting properties can be maintained is unlikely to be prepared, the moisture permeability can be acquired based on a change in moisture permeability by forming the transparent layer of the present invention on an appropriate support having a known moisture permeability.

<Value Obtained by Dividing Moisture Permeability by Equilibrium Moisture Absorptivity>

In order to ensure the transition ratio of the antistatic agent after high temperature and high humidity test and the adhesiveness between the polarizing layer and the transparent layer, a value obtained by dividing the moisture permeability in terms of 5 μm by the equilibrium moisture absorptivity, within the above-described range of the equilibrium moisture absorptivity, is preferably in a range of 500 to 100,000, more preferably in a range of 2000 to 50,000, and particularly preferably in a range of 5000 to 35,000. It is preferable that the value is in the above-described range from the viewpoint that both of the polarizing plate processability and the durability of the polarizing plate with respect to the humidity or moisture heat can be achieved.

<Photoelastic Coefficient>

In the transparent layer used for the laminate of the present invention, the absolute value of a photoelastic coefficient C is preferably 2×10⁻¹² Pa⁻¹ or greater, more preferably in a range of 2×10⁻¹² Pa⁻¹ to 100×10⁻¹² Pa⁻¹, still more preferably in a range of 4×10⁻¹² Pa⁻¹ to 15×10⁻² Pa⁻¹, and most preferably in a range of 5×10⁻¹² Pa⁻¹ to 12×10-12 Pa⁻¹. By setting the absolute value of the photoelastic coefficient of the transparent layer to 2×10⁻¹² Pa⁻¹ or greater, deformation failure can be suppressed or the adhesiveness between the transparent layer and the polarizing layer can be ensured. Further, by setting the absolute value of the photoelastic coefficient of the transparent layer to 100×10⁻¹² Pa⁻¹ or less, a change in retardation caused by the stress birefringence is cancelled out by the orientation birefringence without damaging the display characteristics. Therefore, the retardation stability in a laminate state can be provided. The photoelastic coefficient can be controlled by appropriately selecting the materials and combining two or more materials as necessary. Further, the absolute value of the photoelastic coefficient of the transparent layer may be in the above-described range in at least one optional direction in the plane.

Further, it can be predicted that optical deviation caused by the internal stress is reduced by appropriately controlling the stress birefringence derived from photoelasticity and the orientation birefringence of the transparent layer described below, and thus light unevenness of a liquid crystal display device which is accompanied by the environmental change can be suppressed in a case where the polarizing plate is mounted on the liquid crystal display device.

In the present specification, the photoelastic coefficient of the transparent layer can be measured using a film whose thickness is increased such that self-supporting properties can be maintained as necessary. The photoelastic coefficient of a film can be obtained by cutting out the film to have a size of 5 cm×1 cm such that the measurement direction is set as the longitudinal direction of the film, adjusting the humidity under a temperature condition of 25° C. at a relative humidity of 60% for 2 hours, measuring the in-plane retardation (Re) of the film at a wavelength of 633 nm while a stress (0 to 500 gf) is applied to a sample using a spectroscopic ellipsometer (M-220, manufactured by JASCO Corporation) in the same environment, and performing calculation based on the stress and the inclination of Re.

Further, 1 gf indicates 0.00980665N.

<Orientation Birefringence>

In the transparent layer used for the laminate of the present invention, it is preferable that the sign of the orientation birefringence is opposite to the sign of the photoelastic coefficient and also preferable that a change in retardation accompanied by environmental change is suppressed by cancelling out the orientation birefringence and the stress birefringence occurring in the laminate state as described above. The sign of the orientation birefringence can be controlled by appropriately selecting the materials and combining two or more materials as necessary. In addition, it is preferable that the orientation birefringence (retardation described below) is provided by cancelling the above-described stress birefringence out within the range not damaging the display characteristics and also preferable that an orientation treatment of performing heating or stretching or contracting is carried out before or after the transparent layer and the polarizing layer are laminated.

In the present specification, the sign of the orientation birefringence can be acquired in a slow axis direction at the time of free end uniaxial stretching at a glass transition temperature described below using a film whose thickness is increased such that the self-supporting properties can be maintained as necessary. The birefringence is positive in a case where the slow axis is parallel with the stretching direction and the birefringence is negative in a case where the slow axis is orthogonal to the stretching direction.

<Thickness>

The thickness of the transparent layer used for the laminate of the present invention is in a range of 0.1 to 10 μm, preferably in a range of 0.5 to 7.0 μm, more preferably in a range of 1.0 to 5.0 μm, and still more preferably in a range of 1.5 to 4.0 μm. The processing suitability and the durability of the polarizing plate can be ensured by setting the thickness to 0.1 μm or greater and a preferable retardation range can be obtained by setting the thickness to 10 μm or less. Further, it is preferable that the thickness is in the above-described range because the effect of reducing the light unevenness of the liquid crystal display device which is accompanied by the environmental change in a case where the polarizing plate is mounted on the liquid crystal display device and the effect of reducing the warpage of the liquid crystal panel which is accompanied by the change of the temperature and the humidity can be expected.

<Retardation>

In the present invention, Re and Rth each represent an in-plane retardation at a wavelength of 590 nm and a retardation in a thickness direction at a wavelength of 590 nm.

In the present invention. Re and Rth represent a value measured at a wavelength of 590 nm using AxoScan OPMF-1 (manufactured by OPTO SCIENCE, INC.). The slow axis direction (°) is calculated by inputting the average refractive index ((nx+ny+nz)/3) and the thickness (d) in AxoScan.

Re=(nx−ny)×d

Rth=((nx+ny)/2−nz)×d

nx represents a refractive index of a film in a slow axis direction, ny represents a refractive index of a film in a fast axis direction, and nz represents a refractive index of a film in a thickness direction.

The retardation of the transparent layer used for the laminate of the present invention is not particularly limited, but Re is preferably in a range of 0 to 20 nm, more preferably in a range of 0 to 10 nm, and still more preferably in a range of 0 to 5 nm in a case where the transparent layer is used for a liquid crystal display device having an in-plane switching (IPS) mode. Further, Rth of the transparent layer used for the laminate of the present invention is preferably in a range of −25 to 25 nm, more preferably in a range of −20 to 5 nm, and still more preferably in a range of −10 to 0 nm. In a case where Re and Rth of the transparent layer used for the laminate of the present invention are respectively in the above-described range, light leakage from an oblique direction is further improved and the display quality can be further improved.

<Humidity Dependence of Retardation>

A humidity dependence (ΔRe) of Re of the transparent layer used for the laminate of the present invention is not particularly limited, but is preferably in a range of −20 to 20 nm, more preferably in a range of −10 to 10 nm, and still more preferably in a range of −5 to 5 nm.

The absolute value of the humidity dependence (ΔRth) of Rth of the transparent layer used for the laminate of the present invention is preferably 20 nm or less (in a range of −20 to 20 nm), more preferably in a range of −15 to 15 nm, still more preferably in a range of −10 to 10 nm, and most preferably in a range of −5 to 5 nm.

In the present specification, ΔRe and ΔRth are respectively calculated from a retardation value Re (H %) in an in-plane direction and a retardation value Rth (H %) in a thickness direction under the condition of a relative humidity of H (unit: %) using the following equation.

ΔRe=Re(30%)−Re(80%)

ΔRth=Rth(30%)−Rth(80%)

In the equation, Re (H %) and Rth (H %) are values obtained by adjusting the humidity of the transparent layer under a temperature condition of 25° C. at a relative humidity of (H %) for 24 hours, measuring each retardation value at a relative humidity of H % in conformity with the above-described method of measuring the retardation, and performing calculation. Further, in a case where it is only described as Re without specifying the relative humidity., Re and Rth are values measured at a relative humidity of 60%. In addition, Re and Rth are values at a wavelength of 590 nm unless otherwise noted.

<Modulus of Elasticity>

The modulus of elasticity of the transparent layer used for the laminate of the present invention is not particularly limited, but is preferably in a range of 1.0 to 3.5 GPa, more preferably in a range of 1.5 to 3.3 GPa, and still more preferably in a range of 2.0 to 3.0 GPa.

In the present specification, the modulus of elasticity (tensile modulus of elasticity) of the transparent layer can be measured using a film whose thickness is increased such that the self-supporting properties can be maintained as necessary. The modulus of elasticity of the film can be obtained by cutting out a portion of the film such that the measurement direction becomes the longitudinal direction of the film and a portion to be measured has a size of 10 cm×1 cm, adjusting the humidity under a temperature condition of 25° C. at a relative humidity of 60% for 24 hours, measuring the stress at an elongation of 0.1 and an elongation of 0.5% at a tensile rate of 10%/min using a universal tensile testing machine “STM T50BP” (manufactured by Toyo Baldwin Co., Ltd.), and calculating the modulus of elasticity from the inclination thereof.

<Humidity Expansion Coefficient>

The humidity expansion coefficient of the transparent layer used for the laminate of the present invention is not particularly limited, but is preferably 55 ppm/% RH or less, more preferably in a range of 0 to 40 ppm/% RH, and still more preferably in a range of 0 to 30 ppm/% RH. Since the stress birefringence is considered to be reduced in a case where the humidity expansion coefficient of the transparent layer and the humidity expansion coefficient of the polarizing layer are close to each other, the above-described preferable range can be appropriately corrected according to the characteristics of the polarizing layer.

The humidity expansion coefficient is obtained by cutting out a portion of the film to have a size of 12 cm×5 cm such that the measurement direction becomes the longitudinal direction of the film or the width direction of the film, forming pin holes at intervals of 10 cm using a punch, adjusting the humidity under a temperature condition of 25° C. at a relative humidity of 10% at 25° C. for 24 hours, and measuring the intervals of pin holes using a length measuring device provided with a pair of pins (the measured value is set as L₀). Next, measurement is performed in the same manner as described above by adjusting the humidity under a temperature condition of 25° C. at a relative humidity of 80% for 24 hours (the measured value is set as L₁). The humidity expansion coefficient is calculated using these measured values based on the following equation.

Humidity expansion coefficient [ppm/% RH]=((L₁−L₀)/L₀)/70×10⁶

The value of 70 indicates a difference (%) in the measured humidity.

<Glass Transition Temperature (Tg)>

The glass transition temperature (Tg) of the transparent layer used for the laminate of the present invention or the resin used for the transparent layer is not particularly limited. The Tg can be acquired as a temperature of an intersection between a base line and a tangent on an inflection point from a thermogram obtained by adjusting the humidity under a temperature condition of 25° C. at a relative humidity of 10% for 24 hours, sealing a sample in a measurement pan, and raising the temperature at a rate of 20° C./min using a differential scanning calorimeter “DSC6200” (manufactured by Seiko Instruments Inc.).

<Other Characteristics>

It is preferable that other characteristic values of the transparent layer used for the laminate of the present invention are not particularly limited, and the performance equivalent to that of a known typical polarizing plate protective film can be appropriately implemented, and accordingly, the performance required for a so-called inner film disposed between a polarizing layer and a liquid crystal panel is appropriately implemented. Specific examples of the characteristic values include the haze related to display characteristics, the light transmittance, the spectral characteristics, the moisture-heat resistance of the retardation, the dimensional change rate accompanied by the high temperature and high humidity condition related to mechanical characteristics or processing suitability, the glass transition temperature, the equilibrium moisture absorptivity, the moisture permeability, and the contact angle.

<Layer Configuration>

The transparent layer used for the laminate of the present invention may be formed of a single layer, may have a laminated structure of two or more layers, or may further include a functional layer. However, it is preferable that the transparent layer used for the laminate of the present invention satisfies the above-described characteristics except for the functional layer.

<Composition of Transparent Layer>

The material constituting the transparent layer used for the laminate of the present invention is not particularly limited as long as the transition ratio of the antistatic agent after high temperature and high humidity test is in the preferable range, and a polymer resin or a curable composition containing a reactive monomer can be suitably used.

—Polymer Resin—

The polymer resin constituting the transparent layer used for the laminate of the present invention is not particularly limited as long as the photoelastic coefficient is in the preferable range, and it is preferable that the polymer resin has a polar structure so as to increase the interaction between polymer molecules from the viewpoints of improving the brittleness and the modulus of elasticity. Specific examples thereof include a vinyl aromatic resin (preferably a styrene-based resin), a cellulose-based resin (a cellulose acylate resin, a cellulose ether resin, or the like), a cyclic olefin-based resin, a polyester-based resin, a polycarbonate-based resin, a vinyl-based resin other than a vinyl aromatic resin, a polyimide-based resin, and a polyarylate-based resin. Among these, from the viewpoint of improving the brittleness, a vinyl aromatic resin, a cellulose acylate resin, or a cyclic olefin-based resin is preferable, a vinyl aromatic resin or a cyclic olefin-based resin is more preferable, and a vinyl aromatic resin is still more preferable.

Here, the vinyl aromatic resin is a vinyl-based resin containing at least an aromatic ring, and examples thereof include a styrene-based resin, a divinylbenzene-based resin, a 1,1-diphenylstyrene-based resin, a vinylnaphthalene-based resin, a vinyl anthracene-based resin, a N,N-diethyl-p-aminoethylstyrene-based resin, and a vinylpyridine-based resin. Further, as a copolymer component, a vinyl pyridine unit, a vinyl pyrrolidone unit, or a maleic anhydride unit may be contained as appropriate. Among examples of the vinyl aromatic resin, from the viewpoint of controlling the photoelastic coefficient and the hygroscopicity, a styrene-based resin is more preferable.

The polymer resin may be used alone or in combination of two or more kinds thereof.

Examples of the styrene-based resin include a resin containing 50% by mass or greater of a repeating unit derived from a styrene-based monomer. Here, the styrene-based monomer indicates a monomer having a styrene skeleton in the structure thereof.

Specific examples of the styrene-based monomer include styrene and derivatives thereof. Here, the styrene derivative indicates a compound formed by another group being bonded to styrene, and examples thereof include alkylstyrene such as o-methylstyrene, m-methylstyrene, p-methylstvrene, 2,4-dimethylstyrene, o-ethylstyrene, or p-ethylstyrene; and substituted styrene formed by introducing a hydroxyl group, an alkoxy group, a carboxyl group, or a halogen to a benzene nucleus of styrene such as hydroxystyrene, tert-butoxystyrene, vinylbenzoic acid, o-chlorostyrene, or p-chlorostyrene.

Further, the styrene-based resin may be styrene or a homopolymer of a derivative thereof and examples of the styrene-based resin include those obtained by copolymerizing other monomer components to styrene-based monomer components. Examples of the copolymerizable monomer include alkyl methacrylate such as methyl methacrylate, cyclohexyl methacrylate, methyl phenyl methacrylate, or isopropyl methacrylate; an unsaturated carboxylic acid alkyl ester monomer of alkyl acrylate or the like such as methyl acrylate, ethyl acrylate, butyl acrylate, 2-ethyl hexyl acrylate, or cyclohexyl acrylate, an unsaturated carboxylic acid monomer such as methacrylic acid, acrylic acid, itaconic acid, maleic acid, fumaric acid, or cinnamic acid; an unsaturated dicarboxylic anhydride monomer which is an anhydride of maleic acid, itaconic acid, ethyl maleic acid, methyl itaconic acid, chloromaleic acid; an unsaturated nitrile monomer such as acrylonitrile or methacrylonitrile; and a conjugated diene such as 1,3-butadiene, 2-methyl-1,3-butadiene (isoprene), 2,3-dimethyl-1,3-butadiene, 1,3-pentadiene, or 1,3-hexadiene, and two or more of these can be co-polymerized.

It is preferable that the styrene-based resin is a copolymer of styrene or a styrene derivative and at least one monomer selected from acrylonitrile, maleic anhydride, methyl methacrylate, and 1,3-butadiene.

The polystyrene-based resin is not particularly limited, and examples thereof include a homopolymer of a styrene-based monomer such as general-purpose polystyrene (GPPS) which is a homopolymer of styrene; a copolymer formed of two or more styrene-based monomers as monomer components; a styrene-diene-based copolymer; a copolymer such as a styrene-polymerizable unsaturated carboxylic acid ester-based copolymer; high impact polystyrene (HIPS) such as a mixture of polystyrene and synthetic rubber (for example, polybutadiene or polyisoprene) or polystyrene formed by graft-polymerizing styrene to synthetic rubber; polystyrene (graft type high impact polystyrene, referred to as “graft HIPS”) formed by dispersing a rubber-like elastic body in a continuous phase of a polymer (for example, a copolymer of a styrene-based monomer and a (meth)acrylic acid ester-based monomer) that contains a styrene-based monomer and graft-polymerizing the copolymer to the rubber-like elastic body; and a styrene-based elastomer.

The polystyrene-based resin is not particularly limited and may be hydrogenated. In other words, the polystyrene-based resin may be a hydrogenated polystyrene-based resin (hydrogenated polystyrene-based resin). The hydrogenated polystyrene-based resin is not particularly limited, but a hydrogenated styrene-butadiene-styrene block copolymer (SEBS) which is a resin formed by adding hydrogen to SBS or SIS or a hydrogenated styrene-diene-based copolymer such as hydrogenated styrene-isoprene-styrene block copolymer (SEPS) is preferable. The hydrogenated polystyrene-based resin may be used alone or in combination of two or more kinds thereof.

In addition, the polystyrene-based resin is not particularly limited, but a polar group may be introduced thereinto. In other words, the polystyrene-based resin may be a polystyrene-based resin (modified polystyrene-based resin) into which a polar group has been introduced. Further, examples of the modified polystyrene-based resin include a hydrogenated polystyrene-based resin into which a polar group has been introduced.

The modified polystyrene-based resin is a polystyrene-based resin into which a polar group has been introduced using a polystyrene-based resin as a main chain skeleton. The polar group is not particularly limited, and examples thereof include an acid anhydride group, a carboxylic acid group, a carboxylic acid ester group, a carboxylic acid chloride group, a carboxylic acid amide group, a carboxylate group, a sulfonic acid group, a sulfonic acid ester group, a sulfonic acid chloride group, a sulfonic acid amide group, a sulfonate group, an isocyanate group, an epoxy group, an amino group, an imide group, an oxazoline group, and a hydroxyl group. Among these, an acid anhydride group, a carboxylic acid group, a carboxylic acid ester group, or an epoxy group is preferable; and a maleic anhydride group, or an epoxy group is more preferable. These polar groups may be used alone or in combination of two or more kinds thereof. The modified polystyrene-based resin contains a polar group, which has a high affinity for a polyester-based resin or can be reacted with a polyester-based resin, and is compatible with a polystyrene-based resin, and thus the adhesiveness of the modified polystyrene-based resin to a layer (for example, a surface layer or a B layer) containing a polyester-based resin as a main component or a layer (for example, another A layer) containing a polystyrene-based resin as a main component at room temperature becomes excellent. The polar group may be used alone or in combination of two or more kinds thereof.

The modified polystyrene-based resin is not particularly limited, but a modified product of a hydrogenated styrene-butadiene-styrene block copolymer (SEBS) or a modified product of a hydrogenated styrene-propylene-styrene block copolymer (SEPS) is preferable. In other words, the modified polystyrene-based resin is not particularly limited, but acid anhydride-modified SEBS, acid anhydride-modified SEPS, epoxy-modified SEBS, or epoxy-modified SEPS is preferable; and maleic anhydride-modified SEBS, maleic anhydride-modified SEPS, epoxy-modified SEBS, or epoxy-modified SEPS is more preferable. The modified polystyrene-based resin may be used alone or in combination of two or more kinds thereof.

As the styrene-based resin which can be suitably used in the present invention, from the viewpoint of high heat resistance, a styrene-acrylonitrile copolymer, a styrene-methacrylic acid copolymer, or a styrene-maleic anhydride copolymer can be used.

Further, the styrene-acrylonitrile copolymer, the styrene-methacrylic acid copolymer, and the styrene-maleic anhydride copolymer are preferable since these are highly compatible with an acrylic resin so that a film which has excellent transparency, causes phase separation during utilization, and does not degrade the transparency can be obtained. From this viewpoint, the styrene-acrylonitrile copolymer, the styrene-methacrylic acid copolymer, and the styrene-maleic anhydride copolymer are particularly preferable in a case where a polymer containing methyl methacrylate as a monomer component is used as an acrylic resin.

In a case of the styrene-acrylonitrile copolymer, the copolymer proportion of acrylonitrile in the copolymer is preferably in a range of 1% to 40% by mass. The copolymer proportion thereof is more preferably in a range of 1% to 30% by mass and still more preferably in a range of 1% to 25% by mass. From the viewpoint of excellent transparency, it is preferable that the copolymer proportion of acrylonitrile in the copolymer is in a range of 1% to 40% by mass.

In a case of the styrene-methacrylic acid copolymer, the copolymer proportion of methacrylic acid in the copolymer is preferably in a range of 0.1% to 50% by mass. The copolymer proportion thereof is more preferably in a range of 0.1% to 40% by mass and still more preferably in a range of 0.1% to 30% by mass. From the viewpoint of excellent heat resistance, it is preferable that the copolymer proportion of methacrylic acid in the copolymer is 0.1% by mass or greater. Further, from the viewpoint of excellent transparency, it is preferable that the copolymer proportion thereof is 50% by mass or less.

In a case of the styrene-maleic anhydride copolymer, the copolymer proportion of maleic anhydride in the copolymer is preferably in a range of 0.1% to 50% by mass. The copolymer proportion thereof is more preferably in a range of 0.1% to 40% by mass and more preferably in a range of 0.1% to 30% by mass. It is preferable that the content of the maleic anhydride in the copolymer is 0.1% by mass or greater from the viewpoint of excellent heat resistance and preferable that the content thereof is 50% by mass or less from the viewpoint of excellent transparency.

Among these, from the viewpoint of heat resistance, a styrene-methacrylic acid copolymer and a styrene-maleic anhydride copolymer are particularly preferable.

The styrene-based resin can be used in combination of a plurality of kinds thereof with different compositions, different molecular weights, or the like.

The styrene-based resin can be obtained by a known anion, bulk, suspension, emulsification, or solution polymerization method. Further, in the styrene-based resin, an unsaturated double bond of a benzene ring in a styrene-based monomer or a conjugated diene may be hydrogenated. The hydrogenation rate can be measured using a nuclear magnetic resonance (NMR) device.

As the styrene-based resin, commercially available products may be used and examples thereof include “CLEAREN 530L”. “CLEARREN 730L” (both manufactured by Denka Company Limited), “TUFPRENE 126S”, “ASAPRENE T411” (both manufactured by Asahi Kasei Corporation), “KRATON D1102A”, “KRATON D1116A” (both manufactured by Kraton Corporation), “STYROLUX S”, “STYROLUX T” (both manufactured by Styrolution Group GmbH), “ASAFLEX 840”, “ASAFLEX 860” (both manufactured by Asahi Chemical Co., Ltd.) (all SBS); “679”, “HF77”, “SGP10” (all manufactured by PS Japan Corporation), “DICSTYRENE XC-515”, “DICSTYRENE XC-535” (both manufactured by DIC Corporation) (all GPPS); “475D”, “HO103”, “HT478” (all manufactured by PS Japan Corporation), and “DICSTYRENE GH-8300-5” (manufactured by DIC Corporation) (all HIPS). Examples of commercially available products of the hydrogenated polystyrene-based resin include “TUFTEC H Series” (manufactured by Asahi Chemical Co., Ltd.), “KRATON G Series” (manufactured by Shell Japan Ltd.) (all SEBS), “DYNARON” (manufactured by JSR CORPORATION) (hydrogenated styrene-butadiene random copolymer), and “SEPTON” (manufactured by KURARAY CO., LTD.) (SEPS). Further, examples of commercially available products of the modified polystyrene-based resin include “TUFTEC M Series” (manufactured by Asahi Chemical Co., Ltd.), “EPOFRIEND” (manufactured by DAICEL CORPORATION). “polar group-modified DYNARON” (manufactured by JSR CORPORATION), and “RESEDA” (manufactured by TOAGOSEI CO., LTD.).

As an example of the cyclic olefin-based resin, a thermoplastic resin having a unit of a monomer formed of a cyclic olefin such as norbomene or a polycyclic norbomene-based monomer is exemplified, and this resin is referred to as a thermoplastic cyclic olefin-based resin. This cyclic olefin-based resin may be a hydrogenated product of a ring-opening copolymer formed by using a ring-opening polymer of the cyclic olefin or two or more cyclic olefins or may be an addition polymer of a cyclic olefin, a chain olefin, and an aromatic compound having a polymerizable double bond such as or a vinyl group. A polar group may be introduced into the cyclic olefin-based resin.

In a case where a protective film is formed of a copolymer of a cyclic olefin, a chain olefin, and/or an aromatic compound containing a vinyl group, ethylene or propylene is used as a chain olefin, and styrene, α-methylstyrene, or nucleus alkyl-substituted styrene is used as an aromatic compound containing a vinyl group. Such a copolymer contains 50% by mole or less of the unit of the monomer formed of a cyclic olefin and preferably in a range of 15% to 50% by mole. Particularly in a case where a terpolymer of a cyclic olefin, a chain olefin, and an aromatic compound containing a vinyl group is used for a protective film, the terpolymer may contain a relatively small amount of the unit of the monomer formed of a cyclic olefin as described above. Such a terpolymer typically contains 5% to 80% by mole of the unit of the monomer formed of a chain olefin and 5% to 80% by mole of the unit of the monomer formed of an aromatic compound containing a vinyl group.

As the cyclic olefin-based resin, commercially available products can be appropriately used, and examples thereof include “TOPAS” manufactured by TOPAS ADVANCED POLYMERS GmbH in Germany and sold by Polyplastics Co., Ltd. in Japan; “ARTON” sold by JSR Corporation; “ZEONOR” and “ZEONEX” sold by Zeon Corporation; and “APELLE” sold by Mitsui Chemicals, Inc. (all trade names).

Examples of the cellulose acylate resin include cellulose acetate, cellulose acetate propionate, cellulose propionate, cellulose acetate butyrate, cellulose acetate propionate butyrate, and cellulose acetate benzoate. Among these, cellulose acetate or cellulose acetate propionate is preferable.

Examples of the polycarbonate-based resin include polycarbonate, polycarbonate having a structural unit in which bisphenol A is fluorene-modified, and polycarbonate having a structural unit in which bisphenol A is 1,3-cyclohexylidene-modified.

Examples of the vinyl-based resin other than the vinyl aromatic resin include polyethylene, polypropylene, polyvinylidene chloride, and polyvinyl alcohol.

The weight-average molecular weight (Mw) of the polymer resin constituting the transparent layer used for the polarizing plate of the present invention is not particularly limited, but is preferably in a range of 5000 to 800000, more preferably in a range of 100000 to 600000, and still more preferably in a range of 150000 to 400000.

Further, the weight-average molecular weight of a resin is obtained by measuring the weight-average molecular weight (Mw) in terms of standard polystyrene and molecular weight distribution (Mw/Mn) under the following conditions. In addition, Mn indicates the number average molecular weight in terms of standard polystyrene.

GPC: gel permeation chromatograph device (HLC-8220GPC, manufactured by Tosoh Corporation, column: guard column HXL-H, TSK gel G7000HXL, two sheets of TSK gel GMHXL, and TSK gel G2000HXL (manufactured by Tosoh Corporation) are sequentially linked, eluent: tetrahydrofuran, flow rate: 1 mL/min, sample concentration: 0.7% to 0.8% by mass, sample injection amount: 70 μL, measurement temperature: 40° C., detector: differential refractive index (RI) meter (40° C.), standard material: TSK Standard polystyrene (manufactured by Tosoh Corporation))

The polymer resin constituting the transparent layer used for the laminate of the present invention may be formed of one or two or more kinds thereof. In a case where the transparent layer is formed of multiple layers, the polymer resins of respective layers may be different from one another.

The content of the polymer resin in the transparent layer is preferably in a range of 80% to 100% by mass and more preferably in a range of 90% to 99% by mass with respect to the total mass of the transparent layer.

In a case where the transparent layer is formed of two or more layers, the transparent layer containing a polymer resin as a main component constituting each layer is not particularly limited as long as the transition ratio of the antistatic agent after high temperature and high humidity test is in the preferable range, but a transparent layer formed of a layer containing a styrene-based resin and a layer containing a cyclic olefin-based resin is preferable from the viewpoint of controlling the photoelastic coefficient and the hygroscopicity. Further, from the viewpoint of the adhesiveness between the transparent layer and the polarizing layer through an adhesive layer, it is preferable that the layer to be brought into contact with the adhesive layer is a layer containing a styrene-based resin at the time of preparation of a laminate.

Curable Composition

As another aspect of the transparent layer used in the laminate of the present invention, a known curable composition can be used. The curable composition is not particularly limited, but may be prepared by mixing a curable composition with the above-described polymer resin as appropriate. Further, from the viewpoint of improving the durability of the polarizing plate, it is preferable that the curable composition contains an acrylic monomer and does not contain an epoxy-based monomer.

Specific examples of the reactive monomer include a compound that contains a cyclic aliphatic hydrocarbon group and an unsaturated double bond group and a compound that contains a fluorene ring and an unsaturated double bond group described in paragraphs [0016] to [0044] of JP2014-170130A; and a polyfunctional monomer described in paragraphs [0109] to [0057] of JP2013-231955A, and these can be used as appropriate.

In order to impart water paste adhesiveness between the transparent layer and the polarizing film, a boronic acid monomer described in WO2015/053359A can be used in combination.

Polymerization Initiator

It is preferable that the curable composition contains the following polymerization initiators. A photopolymerization initiator is preferable as the polymerization initiator.

Examples of the photopolymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, onium salts, borate salts, active esters, active halogens, inorganic complexes, and coumarins. The specific examples, preferred aspects, and commercially available products of the photopolymerization initiator are the same as those described in paragraphs [0133] to [0151] of JP2009-098658A, and those can be also suitably used in the present invention.

Various examples thereof are also described in “Latest UV Curing Technology” {Technical Information institute Co., Ltd.} (1991), p. 159 and “UV Curing System” written by Kiyoshi Kato (1989, published by Sogo Gijutsu Center Co., Ltd.), p. 65 to 148 and the examples can be useful in the present invention.

Examples of commercially available light cleavage type photo-radical polymerization initiators include “IRGACURE 651”, “IRGACURE 184”, “IRGACURE 819”, “IRGACURE 907”, “IRGACURE 1870” (initiator formed by mixing CGI-403 and IRGACURE 184 at a mixing ratio of 7:3), “IRGACURE 500”, “IRGACURE 369”, “IRGACURE 1173”, “IRGACURE 2959”, “IRGACURE 4265”. “IRGACURE 4263”, “IRGACURE 127”, and “OXEOl” (manufactured by BASF SE, former Ciba Specialty Chemicals); “KAYACURE DETX-S”. “KAYACURE BP-100”, “KAYACURE BDMK”, “KAYACURE CTX”, “KAYACURE BMS”, “KAYACURE 2-EAQ”, “KAYACURE ABQ”, “KAYACURE CPTX”, “KAYACURE EPD”, “KAYACURE ITX”, “KAYACURE QTX”, “KAYACURE BTC”, and “KAYACURE MCA” (manufactured by Nippon Kayaku Co., Ltd.); and “Esacure (KIP100F KB1, EB3. BP. X33, KTO46, KT37, KIP150, TZT)” (manufactured by Sartomer Company). Further, preferred examples thereof include combinations of these.

The content of the photopolymerization initiator in the curable composition for forming the transparent layer according to the present invention is preferably in a range of 0.5% to 8% by mass and more preferably in a range of 1% to 5% by mass with respect to the total solid content in the composition from the viewpoint that a polymerizable compound (reactive monomer) contained in the composition is polymerized and setting can be made such that starting points are not extremely increased.

Additives

Known additives can be appropriately mixed into the transparent layer used for the laminate of the present invention. Examples of known additives include a low-molecular-weight plasticizer, a leveling agent, an oligomer-based additive, a polyester-based additive, a retardation adjusting agent, a matting agent, a water repellent, an ultraviolet absorbing agent, a deterioration inhibitor, a peeling accelerator, an infrared absorbing agent, an antioxidant, a filler, and a compatibilizer. The type and the addition amount of each material are not particularly limited as long as the photoelastic coefficient is in the preferable range. In addition, in a case where the transparent layer is formed of multiple layers, the types and the amounts of the additives in each layer may be respectively different from one another.

Matting Agent

It is preferable that fine particles are added to the surface of the transparent layer in order to provide slipperiness and prevent blocking. As the fine particles, silica (silicon dioxide, SiO₂) having a surface covered with a hydrophobic group and being in the form of secondary particles is preferably used. Further, as the fine particles, fine particles such as titanium dioxide, aluminum oxide, zirconium oxide, calcium carbonate, talc, clay, calcined kaolin, calcined calcium silicate, hydrated calcium silicate, aluminum silicate, magnesium silicate, or calcium phosphate may be used together with or in place of silica. Examples of commercially available products include R972 and NX90S (trade names, both manufactured by Nippon Aerosil Co., Ltd.).

The fine particles function as a so-called matting agent. Accordingly, even in a case where minute unevenness is formed on a surface of a film due to the addition of fine particles and films overlap each other, the films do not adhere to each other due to this unevenness, and thus the slipperiness of the films is ensured. The minute unevenness formed of protrusions that are formed by fine particles projecting from the film surface exerts high effects of improving the slipperiness and the blocking properties in a case where 10⁴ pieces or more protrusions respectively having a height of 30 nm or greater are present per 1 mm².

In a case where the transparent layer is used as a protective film of the laminate, the film is subjected to a saponification treatment, but the height of a protrusion on the surface of the film becomes small and the density is decreased, and accordingly, moisture absorption occurs due to hydrophilization and swelling easily occurs. Therefore, adhesion tends to occur. Consequently, the minute unevenness formed of protrusions that are formed by fine particles projecting from the film surface exerts high effects of improving the slipperiness and the blocking properties in a case where 10⁴ pieces or more protrusions respectively having a height of 30 nm or greater are present per 1 mm² even after the saponification treatment has been performed (after the saponification treatment).

From the viewpoint of improving the blocking properties and slipperiness, it is preferable that fine particles serving as a matting agent are applied to a surface layer. Examples of the method of applying fine particles to the surface layer include means for applying fine particles through overlay casting or coating.

Fluorine-Based Compound and/or Silicon-Based Compound

It is preferable that the transparent layer used for the laminate of the present invention contains a known compound (water repellent) that exhibits water repellency. Specifically, a fluorine-based compound and/or a silicon-based compound (for example, a silicone compound) is preferable and a fluorine-containing silane compound is more preferable.

As the fluorine-containing silane compound, a compound which is a silane coupling agent that contains a fluorine bonding group and an alkoxysilyl group at the terminal and is capable of forming a silanol bond through a silane coupling reaction is more preferable. Further, among examples of such a compound (silane coupling agent), a fluorine-containing silane compound in which a fluoroalkyl group in the compound is bonded to a Si atom in a ratio of one or less fluoroalkyl group to one Si atom, and the remainder is a hydrolyzable group or a siloxane bonding group is preferable. Examples of the hydrolyzable group here include an alkoxy group, a hydroxyl group is obtained by carrying out hydrolysis, and thus a polycondensate is formed from the fluorine-containing silane compound.

As the water repellent, a commercially available product or a synthetic product may be used. For example, the fluorine-containing silane compound is allowed to react with water (in the presence of an acid catalyst as necessary) while alcohol to be generated as a byproduct in a temperature range of room temperature to 100° C. is distilled off. In this manner, alkoxysilane is (partially) hydrolyzed, a condensation reaction partially occurs, and a hydrolyzate containing a hydroxyl group can be obtained. The degree of hydrolysis or condensation can be appropriately adjusted based on the amount of water used for the reaction. In the present invention, since water is not positively added to the fluorine-containing silane compound solution and a hydrolysis reaction is caused by the moisture or the like in the air after preparation and mainly during drying, it is preferable that the solution is diluted and then used at a low concentration of solid contents.

Specific examples of the water repellent include CF₃(CH₂)₂Si(OCH₃)₃, CF₃(CH₂)₂Si(OC₂H₅)₃, CF₃(CH₂)₂Si(OC₃H₇)₃, CF₃(CH₂)₂Si(OC₄H₉)₃, CF₃(CF₂)₅(CH₂)₂Si(OCH₃)₃, CF₃(CF₂)₅(CH₂)₂Si(OC₂H₅)₃, CF₃(CF₂)S(CH₂)₂Si(OC₃H₇)₃, CF₃(CF₂)₇(CH₂)₂Si(OCH₃)₃, CF₃(CF₂)(CH₂)₂Si(OC₂H)₃, CF₃(CF₂)₇(CH₂)₂Si(OC₃H₇)₃, CF₃(CF₂)₇(CH₂)₂Si(OCH₃)(OC₃H₇)₂, CF₃(CF₂)₇(CH₂)₂Si(OCH₃)₂OC₃H₇, CF₃(CF₂)₇(CH₂)₂SiCH₃(OCH₃)₂, CF₃(CF₂)₇(CH₂)₂SiCH₃(OC₂H₅)₂, CF₃(CF₂)₇(CH₂)₂SiCH₃(OC₃H₇)₂, (CF₃)₂CF(CF₂)₅(CH₂)₂Si(OCH₃)₃, C₇F₁₅CONH(CH₂)₃Si(OC₂H₅)₃, C₈F₁₇SO₂NH(CH₂)₃Si(OC₂H₅)₃, C₈F₁₇(CH₂)₂OCONH(CH₂)₃Si(OCH₃)₃, CF₃(CF₂)₇(CH₂)₂Si(CH₃)(OCH₃)₂, CF₃(CF₂)₇(CH₂)₂Si(CH₃)(OC₂H₅)₂, CF₃(CF₂)₇(CH₂)₂Si(CH₃)(OC₃HT)₂, CF₃(CF₂)₇(CH₂)₂Si(C₂H₅)(OCH₃)₂, CF₃(CF₂)₇(CH₂)₂Si(C₂H₅)(OC₃H₇)₂, CF₃(CH₂)₂Si(CH₃)OCH₃)₂, CF₃(CH₂)₂Si(CH₃)(OC₂H₅)₂, CF₃(CH₂)₂Si(CH₃)(OC₃HT)₂, CF₃(CF₂)₅(CH₂)₂Si(CH₃)(OCH₃)₂, CF₃(CF₂)₅(CH₂)₂Si(CH₃)(OC₃H₇)₂, CF₃(CF₂)₂O(CF₂)₃(CH₂)₂Si(OC₃H₇), C₇F₁₅CH₂O(CH₂)₃Si(OC₂H₅)₃, C₈F₁₇SO₂O(CH₂)₃Si(OC₂H₅)₃, C₈F₁₇(CH₂)₂OCHO(CH₂)₃Si(OCH₃)₃, CF₃(CF₂)₇CH₂CH₂SiCl₃, but the present invention is not limited to these.

Examples of commercially available products of the water repellent include perfluoroalkylsilane (KBM-7803 (chemical formula: CF₃(CF₂)₇CH₂CH₂Si(OCH₃)₃), manufactured by Shin-Etsu Chemical Co., Ltd.) containing an alkoxy group; perfluoroalkylsilane (TSL8232 (chemical formula CF₃(CF₂)₇CH₂CH₂SiCl₃), manufactured by Toshiba Silicone Co., Ltd.) having chlorine atoms, OPTOOL Series (manufactured by DAIKIN INDUSTRIES, LTD.), and FG-5020 (manufactured by Fluoro Technology Co., Ltd.).

These water repellents can be used alone or in combination of two or more kinds thereof. Among these, CF₃(CF₂)₇CH₂CH₂SiC₃, CF₃(CH₂)₂Si(OCH₃)₃, CF₃(CF₂)₇(CH₂)₂Si(OCH₃)₃ are preferable.

Further, the water repellent may contain hydrophobic fine particles disclosed in JP2010-189059A, JP2011-73219A, JP2011-184082A, and the like as appropriate.

Leveling Agent

A known leveling agent (surfactant) can be appropriately mixed into the transparent layer used for the laminate of the present invention. Examples of the leveling agent include known compounds of the related art. Among these, a fluorine-containing surfactant is particularly preferable. Specifically, the compounds described in paragraphs [0028] to [0056] in the specification of JP2001-330725A are exemplified.

Polyester-Based Additive

A known polyester-based additive can be appropriately added to the transparent layer used for the laminate of the present invention. The transparent layer can be prepared using a release film (base film) as described below according to a melt extrusion method or a coating method. According to these methods, in a case where a compound that decreases a difference in surface energy between the transparent layer and the release film or a compound that has a permeability into the release film is added to the transparent layer, an effect of improving the peeling force between the transparent layer and the release film is exerted. Further, in a case where a compound that decreases the molecular orientation of the transparent layer and has a small refractive index anisotropy is added to the transparent layer, an effect of reducing the retardation is exerted. In a case where a compound having a relatively rigid structure such as phthalic acid is added to the transparent layer, an effect of increasing the hardness of the transparent layer can also be expected.

Examples of the polyester-based additive include a polyester-based compound. Specifically, an oligomer of a polyester-based compound described in paragraphs [0027] to [0034] of JP2009-98674A can be used. The content of the oligomer of the polyester-based compound is preferably in a range of 0.1% to 50% by mass, more preferably in a range of 1% to 30% by mass, and particularly preferably in a range of 3% to 10% by mass with respect to the content of the resin constituting the transparent layer.

In a case where the release film used for preparation of the transparent layer used for the laminate of the present invention is a polyester-based film, particularly an aromatic polyester-based compound (including an oligomer) can be preferably used, and specific examples of the compound are described below.

The aromatic polyester-based compound has a repeating unit derived from a dicarboxylic acid and a repeating unit derived from a diol. Among the repeating units derived from a dicarboxylic acid, in a case where the molar ratio of the repeating unit derived from an aliphatic dicarboxylic acid is set as m and the molar ratio of the repeating unit derived from an aromatic dicarboxylic acid is set as n, a ratio m:n is in a range of 0:10 to 5:5. The hardness of the material itself is increased by increasing the ratio of the unit derived from an aromatic dicarboxylic acid, and thus an effect of increasing the hardness of the transparent layer can also be expected.

The number average molecular weight (Mn) of the aromatic polyester-based compound according to the present invention is preferably in a range of 600 to 30000, more preferably in a range of 700 to 10000, still more preferably in a range of 700 to 5000, and most preferably in a range of 750 to 3000. In a case where the number average molecular weight of the aromatic polyester-based compound is 600 or greater, the volatility during a drying step or a stretching step is lowered, and failure or step contamination due to the volatilization under a high temperature condition during stretching of the laminated film formed of the transparent layer and the release film used for the laminate of the present invention is unlikely to occur. Further, in a case where the number average molecular weight thereof is 30000 or less, the compatibility with the material of the transparent layer and the solubility of the transparent layer in a solvent are increased and bleeding out during the production step is unlikely to occur.

The number average molecular weight of the aromatic polyester-based compound can be measured and evaluated using gel permeation chromatography (GPC).

Further, the measurement conditions using GPC are the same as described above.

It is preferable that the aromatic polyester-based compound is synthesized using a diol having 2 to 10 carbon atoms and a dicarboxylic acid having 4 to 10 carbon atoms. As the synthesis method, a known method such as a dehydration condensation reaction between a dicarboxylic acid and a diol or addition of dicarboxylic anhydride to glycol and a dehydration condensation reaction can be used.

Further, the number of carbon atoms in a dicarboxylic acid indicates the number of carbon atoms in a carboxylic acid group (COOH).

Here, it is preferable that the aromatic polyester-based compound is a polyester-based compound obtained by synthesizing a diol and an aromatic dicarboxylic acid which is a dicarboxylic acid.

Hereinafter, the dicarboxylic acid and the diol which are preferably used for synthesis of the aromatic polyester-based compound according to the present invention will be described.

—Dicarboxylic Acid—

As the dicarboxylic acid, both of an aliphatic dicarboxylic acid and an aromatic dicarboxylic acid can be used.

Examples of the aromatic dicarboxylic acid include phthalic acid, terephthalic acid, and isophthalic acid. Among these, phthalic acid and terephthalic acid are preferable, and adhesion between the transparent layer and the release film in a case where a polyester-based film is used as the release film can be controlled, and the hardness of the transparent layer and the durability of the laminate (durability of the polarizing plate) according to the present invention can be improved. Further, phthalic acid is particularly preferable from the viewpoint of suppressing the retardation of the transparent layer to be low. A combination of two or more kinds of aromatic dicarboxylic acids may be used. Specifically, a combination of phthalic acid and terephthalic acid may be exemplified. From the above-described viewpoint, it is preferable to increase the ratio of the phthalic acid among the examples of the aromatic dicarboxylic acid, and the ratio of the repeating unit derived from phthalic acid to the repeating unit derived from the dicarboxylic acid contained in the aromatic polyester-based compound is preferably 70% by mole or greater, more preferably 80% by mole or greater, and particularly preferably 90% by mole or greater. Further, the ratio (molar ratio) between phthalic acid and terephthalic acid can be changed from the viewpoint of controlling the Rth of the transparent layer. For example, in a case where the Rth is expected to be decreased, the ratio between phthalic acid and terephthalic acid is preferably in a range of 5:5 to 10:0, more preferably in a range of 7:3 to 10:0, and particularly preferably 10:0.

Examples of the aliphatic dicarboxylic acid include oxalic acid, malonic acid, succinic acid, maleic acid, fumaric acid, glutaric acid, adipic acid, suberic acid, azelaic acid, cyclohexanedicarboxylic acid, and sebacic acid. Among these, succinic acid and adipic acid are preferable, and adipic acid is particularly preferable.

The number of carbon atoms in the dicarboxylic acid used in the present invention is preferably in a range of 4 to 10 and more preferably in a range of 4 to 8. In the present invention, a mixture of two or more kinds of dicarboxylic acids may be used, and it is preferable that the average number of carbon atoms in two or more kinds of dicarboxylic acids is in the above-described range. It is preferable that the number of carbon atoms in the dicarboxylic acid is in the above-described range from the viewpoint that the compatibility with the material of the transparent layer and the solubility of the transparent layer in a solvent are increased and bleeding out during the production step is unlikely to occur.

The aliphatic dicarboxylic acid and the aromatic dicarboxylic acid may be used in combination. Specific examples of the combination include a combination of adipic acid and phthalic acid, a combination of adipic acid and terephthalic acid, a combination of succinic acid and phthalic acid, and a combination of succinic acid and terephthalic acid.

In a case where the aliphatic dicarboxylic acid and the aromatic dicarboxylic acid are used in combination, the molar ratio of the repeating unit derived from the aliphatic dicarboxylic acid is set as m and the molar ratio of the repeating unit derived from the aromatic dicarboxylic acid is set as n, the ratio (molar ratio) m:n is in a range of 0:10 to 3:7 and more preferably in a range of 0:10 to 2:8.

—Diol—

Examples of the diol include an aliphatic diol and an aromatic diol, and an aliphatic diol is preferable.

Examples of the aliphatic diol include alkyl diol and alicyclic diols, and specific examples thereof include ethylene glycol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentyl), 2-n-butyl-2-ethyl-1,3-propanediol (3,3-dimethylolheptane), 3-methyl-1,5-pentanediol, 1,6-hexanediol, 1,4-cyclohexanediol, 1,4-cyclohexanedimethanol, 2,2,4-trimethyl-1,3-pentanediol, 2-ethyl-1,3-hexanediol, 2-methyl-1,8-octanediol, 1,9-nonanediol, 1,10-decanediol, and diethylene glycol.

As the aliphatic diol, at least one selected from ethylene glycol, 1,2-propanediol, and 1,3-propanediol is preferable, at least one selected from ethylene glycol and 1,2-propanediol is more preferable, and ethylene glycol is still more preferable. In a case of a combination of two or more kinds thereof, it is preferable to use ethylene glycol and 1,2-propanediol.

The number of carbon atoms in the diol is preferably in a range of 2 to 10, more preferably in a range of 2 to 6, and particularly preferably in a range of 2 to 4. In a case of using a combination of two or more kinds of diols, it is preferable that the average number of carbon atoms in two or more kinds of diols is in the above-described range. It is preferable that the number of carbon atoms in the diol is in the above-described range from the viewpoint that the compatibility with the material of the transparent layer and the solubility of the transparent layer in a solvent are increased and bleeding out during the production step is unlikely to occur.

—Sealing—

Both terminals of the aromatic polyester-based compound may be sealed or unsealed, but it is preferable that the terminals are sealed with an alkyl group or an aromatic group in a case where the molecular weight of the aromatic polyester-based compound is low, that is, in a case of a so-called oligomer. By protecting the terminals with a hydrophobic functional group, the transition ratio of the antistatic agent after high temperature and high humidity test can be lowered, the protection of the terminals is effective for improvement of the durability of the polarizing plate, and an effect of delaying hydrolysis of an ester group is also expected.

It is preferable that both terminals of the aromatic polyester-based compound are protected with a monoalcohol residue or a monocarboxylic acid residue such that both terminals are not formed of a carboxylic acid or an OH group. The hydroxyl value of the aromatic polyester-based compound is preferably 10 mgKOH/g or less from the viewpoint of improving the durability of the polarizer, more preferably 5 mgKOH/g or less, and particularly preferably 0 mgKOH/g.

In a case where both terminals of the aromatic polyester-based compound are sealed, it is preferable that the terminals are sealed by causing a reaction with a monocarboxylic acid. At this time, both terminals of the aromatic polyester-based compound are formed of a monocarboxylic acid residue. Here, the residue indicates a partial structure of the aromatic polyester-based compound which has characteristics of the monomer forming the aromatic polyester-based compound. For example, the monocarboxylic acid residue formed from monocarboxylic acid R—COOH is R—CO—. As the monocarboxylic acid residue, an aliphatic monocarboxylic acid residue is preferable, an aliphatic monocarboxylic acid residue having 2 to 22 carbon atoms is more preferable, an aliphatic monocarboxylic acid residue having 2 or 3 carbon atoms is still more preferable, and an aliphatic monocarboxylic acid residue having 2 carbon atoms is particularly preferable. Further, the number of carbon atoms in the monocarboxylic acid residue (R—CO—) is the number of carbon atoms in R and carbon atoms in —CO—.

In a case where the number of carbon atoms in the monocarboxylic acid residue of both terminals of the aromatic polyester-based compound is 3 or less, the volatility is degraded, the weight reduction due to heating of the aromatic polyester-based compound is not increased, and occurrence of step contamination or occurrence of planar failure can be reduced. In other words, as monocarboxylic acids used for sealing, the aliphatic monocarboxylic acid is more preferable than the aromatic monocarboxylic acid from the viewpoint of the production suitability and the planar quality. As the monocarboxylic acid, an aliphatic monocarboxylic acid having 2 to 22 carbon atoms is more preferable, an aliphatic monocarboxylic acid having 2 or 3 carbon atoms is still more preferable, and an aliphatic monocarboxylic acid residue having 2 carbon atoms is particularly preferable. For example, acetic acid, propionic acid, butanoic acid, or a derivative thereof is preferable, acetic acid or propionic acid is more preferable, and acetic acid (the terminal is formed of an acetyl group) is most preferable. The monocarboxylic acid used for sealing may be used by mixing two or more kind thereof.

In a case where both terminals of the aromatic polyester-based compound are sealed, the state thereof at room temperature is unlikely to be in a solid shape, and handling properties become excellent in some cases. Further, a transparent layer having excellent humidity stability and durability of a polarizing plate can be obtained.

—Synthesis Method—

The aromatic polyester-based compound can be easily synthesized according to any conventional method such as a heat melt condensation method of carrying out a polyesterification reaction or a transesterification reaction of a dicarboxylic acid containing the aromatic dicarboxylic acid, a diol, a monocarboxylic acid for sealing the terminal as necessary, or monoalcohol or an interfacial condensation method of carrying out a reaction between acid chlorides of these acids and glycols.

Examples of commercially available products of the polyester-based compound include ester-based resin polyester (such as LP050, TP290, LP035, LP033, TP217, or TP220) (manufactured by Nippon Synthetic Chem Industry Co., Ltd.) and ester-based resin Vylon (such as VYLON 245. VYLON GK890, VYLON 103, VYLON 200, or GK880) (manufactured by TOYOBO CO., LTD.).

<Method of Producing Transparent Layer>

The transparent layer used for the laminate of the present invention can be prepared according to a known solution film formation method, a melt extrusion method, or a method (coating method) of forming a coating layer on a release film (base film) using a known method. The method of producing the transparent layer can be combined with stretching as appropriate, and a melt extrusion method or a coating method can be particularly preferably used.

According to the solution film formation method, a solution obtained by dissolving the material of the transparent layer in an organic solvent or water is prepared and then uniformly cast on a support after a concentration step or a filtration step is performed as appropriate. Next, the damp-dried film is peeled off from the support, both ends of the web are appropriately held using a clip or the like, and the solvent is dried in a drying zone. Further, the stretching can be separately performed during or after the film is dried.

According to the melt extrusion method, the material of the transparent layer is melted by heat, the filtration step or the like is performed as appropriate, and the melted material is uniformly cast on a support. Next, the cooled and hardened film can be peeled off from the support and then stretched as appropriate. In a case where the main material of the transparent layer of the present invention is a thermoplastic polymer resin, a thermoplastic polymer resin is also selected as the main material of the release film, and film formation can be carried out using a polymer resin in a melted state according to a co-extrusion method. At this time, the adhesiveness between the transparent layer and the release film can be controlled by adjusting the type of the polymer in the transparent layer and the release film or the additives to be mixed into each layer or adjusting the stretching temperature, the stretching speed, or the stretching ratio of the co-extruded film.

Examples of the co-extrusion method include a co-extrusion T-die method, a co-extrusion inflation method, and a co-extrusion lamination method. Among these, a co-extrusion T-die method is preferable. The co-extrusion T-die method is classified into a feed block system and a multi-manifold system. Among these, from the viewpoint of reducing a variation in thickness, a multi-manifold system is particularly preferable.

In a case where the co-extrusion T-die method is employed, the melting temperature of a resin in an extruder having a T die is a temperature equal to or higher than the glass transition temperature (Tg) of each resin by preferably 80° C. and more preferably 100° C. Further, the melting temperature thereof is a temperature equal to or lower than the glass transition temperature of each resin by preferably 180° C. and more preferably 150° C. The fluidity of the resin can be sufficiently increased by setting the melting temperature of the resin in an extruder to higher than or equal to the lower limit of the above-described range. Further, deterioration of the resin can be prevented by setting the melting temperature thereof to lower than or equal to the upper limit.

A sheet-like molten resin extruded from an opening of a die is usually brought into contact with a cooling drum. A method of bringing the molten resin into close contact with a cooling drum is not particularly limited, and examples thereof include an air knife system, a vacuum box system, and an electrostatic adhesion system.

The number of cooling drums is not particularly limited and is typically 2 or more. Further, as a method of arranging the cooling drums, a method of arranging cooling drums in a straight line shape, a Z shape, or an L shape is exemplified and not particularly limited. Further, a method of passing a molten resin extruded from an opening of a die through a cooling drum is not particularly limited.

The state in which the extruded sheet-like resin is in close contact with a cooling drum is changed due to the temperature of the cooling drum. In a case where the temperature of the cooling drum is increased, the state of close contact becomes better, but there is a possibility that the sheet-like resin is not peeled off from the cooling drum and wound around the drum at the time of an extreme increase in temperature. Therefore, in a case where the glass transition temperature of the resin on a side of the layer in contact with the drum in the resin extruded from a die is set as Tg, the temperature of the cooling drum is preferably (Tg+30°) C or lower and more preferably in a range of (Tg−5°) C to (Tg−45°) C. In this manner, defects such as slide or scratches can be prevented.

Here, it is preferable that the content of the residual solvent in the pre-stretched film is set to be small. As means for this, (1) means for reducing the amount of the residual solvent of the resin serving as a raw material; and (2) means for pre-drying the resin before the pre-stretched film is formed are exemplified. The pre-drying is performed using a hot air dryer by forming the resin in the pellet form. The drying temperature is preferably 100° C. or higher, and the drying time is preferably 2 hours or longer. By performing the pre-drying, the amount of the residual solvent in the pre-stretched film can be reduced and foaming of the extruded sheet-like resin can be prevented.

According to the coating method, the film which is the base material is coated with the material of the transparent layer to form a coating layer. Since the surface of the base material may be coated with a release agent or the like as appropriate in order to control the adhesiveness between the coating layer and the surface of the base material. After the coating layer is laminated on the polarizing layer through an adhesive or a pressure sensitive adhesive in the post-step, the coating layer can be used by peeling the release film off therefrom. The entire release film can be stretched as appropriate in a state in which a polymer solution or the coating layer is laminated on the release film so that the optical characteristic or mechanical physical properties can be adjusted.

The solvent used in the solution of the material of the transparent layer can be appropriately selected from the viewpoints of capability of dissolving or dispersing the material of the transparent layer, easily obtaining a uniform surface state in the coating step and the drying step, capability of ensuring liquid preservability, and having a moderate saturated vapor pressure.

It is preferable that the transparent layer is subjected to a hydrophilic treatment such as a known glow discharge treatment, corona discharge treatment, or alkali saponification treatment. Further, a corona discharge treatment is most preferably used. The methods or the like disclosed in JP 1994-94915A (JP-H₀₆-94915A) or JP1994-118232A (JP-H₀₆-118232A) are preferably applied.

The obtained film can be subjected to a heat treatment step, a superheated steam contact step, or an organic solvent contact step. In addition, the film can be applied as a hard coat film, an antiglare film or an antireflection film by performing a surface treatment thereon.

(Release Film)

The release film used for forming the transparent layer according to the coating method has a film thickness of preferably 5 to 100 μm, more preferably 10 to 75 μm, and still more preferably 15 to 55 μm. It is preferable that the film thickness thereof is 5 μm or greater since sufficient mechanical strength is likely to be ensured and failure such as curling, wrinkling, or buckling is unlikely to occur. Further, it is preferable that the film thickness thereof is 100 μm or less since a surface pressure applied to a laminated film of the transparent layer of the present invention and the release film is easily adjusted to be in an appropriate range in a case where the laminated film is stored in a long roll form and adhesion failure is unlikely to occur.

The surface energy of the release film is not particularly limited, but the adhesive strength between the transparent layer and the release film can be adjusted by adjusting the relationship between the surface energy of the material of the transparent layer or the coating solution and the surface energy of the surface on a side of the release film where the transparent layer is formed. A difference in surface energy is set to be small, the adhesive strength tends to be increased. Further, a difference in surface energy is set to be large, the adhesive strength tends to be decreased. Accordingly, the difference can be appropriately set.

The surface energy of the release film can be calculated using the method of Owens based on the contact angle values of water and methylene iodide. The contact angle can be measured using, for example, DM901 (manufactured by Kyowa Interface Science Co., Ltd., contact angle meter).

The surface energy of the release film on a side where the transparent layer is formed is preferably in a range of 41.0 to 48.0 mN/m and more preferably in a range of 42.0 to 48.0 mN/m. It is preferable that the surface energy is 41.0 mN/m or greater since the uniformity in thickness of the transparent layer can be increased. Further, it is preferable that the surface energy is 48.0 mN/m or less since the peeling force of the transparent layer from the release film is easily controlled to be in an appropriate range.

The surface unevenness of the release film is not particularly limited and can be adjusted for the purpose of preventing adhesion failure in a case where the laminated film of the transparent layer and the release film is stored in a long roll form according to the relationship among the surface energy of the surface of the transparent layer, the hardness, the surface unevenness, the surface energy of the surface of the release film on a side opposite to a side where the transparent layer is formed, and the hardness. In a case where the surface unevenness is increased, the adhesion failure tends to be suppressed. Further, in a case where the surface unevenness is decreased, the surface unevenness of the transparent layer is decreased so that the haze of the transparent layer tends to be decreased. Therefore, the surface unevenness can be appropriately set.

As such a release film, known materials or films can be used as appropriate. Specific examples of the materials include a polyester-based polymer, a olefin-based polymer, a cycloolefin-based polymer, a (meth)acrylic polymer, a cellulose-based polymer, and a polyamide-based polymer. Further, a surface treatment can be performed as appropriate for the purpose of adjusting the surface properties of the release film. For example, a corona treatment, a room temperature plasma treatment, or a saponification treatment can be performed in order to decrease the surface energy, and a silicone treatment, a fluorine treatment, or an olefin treatment can be performed in order to increase the surface energy.

(Peeling Force Between Transparent Layer and Release Film)

In a case where the transparent layer used for the laminate of the present invention is formed according to the coating method, the peeling force between the transparent layer and the release film can be controlled by adjusting the material of the transparent layer, the material of the release film, the internal strain of the transparent layer, or the like. The peeling force can be measured by performing a test of peeling the release film in a direction of an angle of 90°, and the peeling force measured at a rate of 300 mm/min is preferably in a range of 0.001 to 5 N/25 mm, more preferably in a range of 0.01 to 3 N/25 mm, still more preferably in a range of 0.1 to 1 N/25 mm, and most preferably in a range of 0.15 to 0.8 N/25 mm. In a case where the peeling force is 0.001 N/25 mm or greater, it is possible to prevent the release film from peeling off in steps other than the peeling step. In a case where the peeling force is 5 N/25 mm or less, peeling failure (such as zipping or cracking of the transparent layer) in the peeling step can be prevented.

(Polarizing Layer)

As the polarizing layer used for the laminate of the present invention, a polarizing layer containing an iodine-polyvinyl alcohol complex is exemplified. For example, a polyvinyl alcohol film after being immersed in an iodine solution and then stretched can be used.

(Adhesive Layer)

In a case of using such a polarizing layer, the surface of the transparent layer, on which the surface treatment has been performed, used for the laminate of the present invention can be allowed to directly adhere to one surface or both surfaces of the polarizing layer using an adhesive formed of an aqueous solution of a polyvinyl alcohol-based resin. As the adhesive, an aqueous solution of polyvinyl alcohol or polyvinyl acetal (such as polyvinyl butyral), latex of a vinyl-based polymer (for example, polybutyl acrylate), or a UV adhesive (an epoxy-based or acrylic ultraviolet curable composition) can be used. From the viewpoint of suppressing deformation failure of the laminate, it is preferable to use a solution-based adhesive and an aqueous solution of completely saponified polyvinyl alcohol is most preferable. Further, from the viewpoint of improving the adhesiveness between the transparent layer and the polarizing layer, an ultraviolet curable adhesive can also be preferably used. The type of ultraviolet curable adhesive is not particularly limited, and an epoxy-based ultraviolet curable adhesive described in JP2015-187744A and an acrylate-based ultraviolet curable adhesive described in JP2015-11094A are preferably used.

(Laminate)

The laminate of the present invention can be prepared using a known method and is prepared by adhering the polarizing layer and the transparent layer to each other such that an angle between an absorption axis of the polarizing layer and a direction in which an acoustic wave propagating velocity of the transparent layer becomes maximum is parallel or orthogonal to each other.

In the present specification, a case where two straight lines are in parallel with each other includes not only a case where an angle between two straight lines is 0° but also a case where an error is in an optically acceptable level. Specifically, in the case where two straight lines are in parallel with each other, the angle between two straight lines is preferably in a range of 0°±10°, more preferably in a range of 0°±5°, and particularly preferably in a range of 0°±1°. Similarly, a case where two straight lines are orthogonal (perpendicular) to each other includes not only a case where an angle between two straight lines is 90° but also a case where an error is in an optically acceptable level. Specifically, in the case where two straight lines are orthogonal (perpendicular) to each other, the angle between two straight lines is preferably in a range of 90°±10°, more preferably in a range of 90°±5°, and particularly preferably in a range of 90°±1°.

Another transparent layer may further adhere to the surface opposite to the surface on which the transparent layer is adhered to the polarizing layer or a known optical film of the related art may adhere thereto. In a case where a thin transparent layer is adhered to the opposite surface, the pencil hardness may be degraded in a case where the laminate of the present invention is adhered to the liquid crystal panel. For the purpose of improving the pencil strength, it is preferable that the transparent layer adhered to the opposite surface contains a crosslinkable material or fine particles having a high hardness. Further, it is preferable that the thickness of the polarizing layer or the thickness of the pressure sensitive adhesive used for adhesion of the laminate of the present invention to the liquid crystal panel is decreased because the deformation of the laminate of the present invention can be suppressed in a state of being adhered to the panel and the pencil hardness in an actual use form can be increased.

The optical characteristics and the materials of the known optical film of the related art are not particularly limited, and a film containing a cellulose ester resin, an acrylic resin, a cyclic olefin resin, and/or polyethylene terephthalate (or containing these as main components) can be preferably used. Further, an optically isotropic film or an optically anisotropic phase difference film may be used.

As the known optical film of the related art which contains a cellulose ester resin, FUJITAC TD40UC (manufactured by Fujifilm Corporation) can be used.

As the known optical film of the related art which contains an acrylic resin, an optical film which contains a (meth)acrylic resin containing a styrene-based resin described in JP4570042B; an optical film which contains a (meth)acrylic resin having a glutarimide ring structure in the main chain described in JP5041532B; an optical film containing (meth)acrylic resin having a lactone ring structure described in JP2009-122664A; and an optical film which contains a (meth)acrylic resin having a glutaric anhydride unit described in JP2009-139754A can be used.

Further, as the known optical film of the related art which contains a cyclic olefin resin, a cyclic olefin-based resin film described after the paragraph 100291 of JP2009-237376A; or a cyclic olefin resin film which contains an additive that decreases Rth described in JP4881827B or JP2008-063536A can be used.

(Peeling of Release Film from Transparent Layer)

In a case of a melt extrusion method or a coating method which can be preferably used for preparing the transparent layer of the present invention, the method includes a step of peeling and removing the release film in the laminated film formed of the transparent layer and the release film in a stage before a step of forming a layer that contains an antistatic agent on the transparent layer and after a step of adhering the polarizing layer and the transparent layer to each other. The release film is peeled and removed according to the same method as a step of peeling a separator (release film) that is performed on a typical polarizing plate provided with a pressure sensitive adhesive. The release film may be peeled directly after a step of laminating the transparent layer and the polarizing layer of the present invention on each other using an adhesive and drying the laminate or may be peeled separately after a step of temporarily winding the film in a roll shape after the drying step.

(Layer Containing Antistatic Agent)

The layer containing an antistatic agent used for the laminate according to the present invention is not particularly limited as long as the layer contains an antistatic agent. From the viewpoint of obtaining excellent antistatic properties, the modulus of elasticity of the layer is preferably less than 1 GPa, more preferably 0.1 GPa or less, and still more preferably 0.05 GPa or less. Specifically, a pressure sensitive adhesive composition containing an antistatic agent is exemplified.

Pressure Sensitive Adhesive Composition

A pressure sensitive adhesive composition of the present invention contains a polymer having a glass transition temperature of 0° C. or lower as a base polymer. The pressure sensitive adhesive composition can be used without particular limitation as long as the pressure sensitive adhesive composition contains a polymer having a glass transition temperature (Tg) of 0° C. or lower as a base polymer and tackiness can be exhibited. Examples thereof include an acrylic pressure sensitive adhesive, a urethane-based pressure sensitive adhesive, a polyester-based pressure sensitive adhesive, a synthetic rubber-based pressure sensitive adhesive, a natural rubber-based pressure sensitive adhesive, and a silicone-based pressure sensitive adhesive. Among these, an acrylic pressure sensitive adhesive is particularly preferable from the viewpoint of easily controlling the pressure sensitive adhesive characteristics.

According to the present invention, it is preferable that the polymer having a glass transition temperature (Tg) of 0° C. or lower is a (meth)acrylic polymer and more preferable that the polymer thereof is a (meth)acrylic polymer containing a hydroxyl group and a carboxyl group. A pressure sensitive adhesive with excellent pressure sensitive adhesive characteristics can be designed by using the polymer having a glass transition temperature (Tg) of 0° C. or lower, and the pressure sensitive adhesive characteristics can be easily controlled by using the (meth)acrylic polymer, which is preferable. Further, by using the (meth)acrylic polymer containing a hydroxyl group and a carboxyl group, crosslinking can be easily controlled by the hydroxyl group and the shear force is improved or an increase in pressure sensitive adhesive force with time can be prevented by the carboxyl group, which is preferable. Particularly, the shear force of the pressure sensitive adhesive (layer) is improved by using the (meth)acrylic polymer containing a hydroxyl group and a carboxyl group, and thus the pressure sensitive adhesive is adhered to an adherend. Therefore, curling caused by the adherend can be suppressed, and occurrence of slide or deviation between (the interface) the pressure sensitive adhesive and the adherend can be suppressed, which is preferable.

According to the present invention, the pressure sensitive adhesive composition contains the polymer having a glass transition temperature (Tg) of 0° C. or lower as a base polymer, and the content of the polymer having a glass transition temperature (Tg) of 0° C. or lower is more preferably 100% by mass with respect to 100% by mass of the base polymer. Further, the (meth)acrylic polymer in the present invention indicates an acrylic polymer and/or a methacrylic polymer, and (meth)acrylate indicates acrylate and/or methacrylate.

The weight-average molecular weight (Mw) of the (meth)acrylic polymer is preferably in a range of 100000 to 5000000, more preferably in a range of 200000 to 4000000, still more preferably in a range of 300000 to 3000000, and most preferably in a range of 40000 to 700000. In a case where the Mw is less than 100000, the cohesive force of the pressure sensitive adhesive layer to be obtained is decreased, and thus adhesive residue tends to occur. Further, in a case where the Mw is greater than 5000000, the fluidity of the polymer is degraded, and wetting of the adherend (for example, a polarizing plate serving as an optical member) becomes insufficient, and this may result in blistering that occurs between the adherend and the pressure sensitive adhesive layer (pressure sensitive adhesive composition layer) of the pressure sensitive adhesive sheet. Moreover, the Mw is obtained by performing measurement according to a gel permeation chromatography (GPC) method.

The measurement conditions using GPC are the same as described above.

The glass transition temperature (Tg) of the polymer (for example, the (meth)acrylic polymer) having a glass transition temperature of 0° C. or lower is 0° C. or lower, preferably −10° C. or lower, more preferably −40° C. or lower, and still more preferably −60° C. or lower (typically −100° C. or higher). In a case where the Tg is higher than 0° C., the polymer is unlikely to flow. Further, for example, wetting of the adherend (for example, a polarizing plate serving as an optical member) become insufficient and this may result in blistering that occurs between the adherend and the pressure sensitive adhesive layer (pressure sensitive adhesive composition layer). Further, by setting the Tg to 0° C. or lower, a pressure sensitive adhesive composition with excellent wettability to an adherend and light peeling properties is likely to be obtained. Further, the glass transition temperature (Tg) of the polymer (for example, the (meth)acrylic polymer) having a glass transition temperature of 0° C. or lower can be adjusted to be in the above-described range by changing the monomer components to be used and the compositional ratio as appropriate.

The base polymer may be crosslinked by a crosslinking agent and may contain a known crosslinking catalyst or a known crosslinking retardant as appropriate. The antistatic agent described below is added to the base polymer such that the pressure sensitive adhesive layer to be formed by coating a base material such as an optical sheet or a protective film with the pressure sensitive adhesive composition has a surface resistance value of approximately 1×10⁸ to 1×10¹¹ Ω/cm².

Antistatic Agent

The antistatic agent may contain an ionic compound containing an organic cationic compound.

The ionic compound is selected so as to have compatibility with the base polymer and the organic solvent used for the preparation of the pressure sensitive adhesive composition and to maintain the transparency of the pressure sensitive adhesive composition in a case where the ionic compound is added to the base polymer. Further, the ionic compound is selected such that the surface resistance value of the pressure sensitive adhesive composition in a state of being laminated on another optical layer is set to 1×10¹¹ Ω/cm² or less.

The ionic compound may be at least one selected from an imidazolium salt, a pyridinium salt, an alkyl ammonium salt, an alkyl pyrrolidinium salt, and an alkyl phosphonium salt.

Examples of the imidazolium salt include 1,3-dimethylimidazolium chloride, 1-butyl-2,3-dimethylimidazolium chloride, 1-butyl-3-methylimidazolium bromide, 1-butyl-3-methylimidazolium chloride, 1-butyl-3-methylimidazolium methane sulfonate, 1-butyl-1-(3,3,4,4,5,5,6,6,7,7,8,8,8-tridecafluorooctyl)-imidazolium hexafluorophosphate, 1-ethyl-3-methylimidazolium bromide, 1-ethyl-3-methylimidazolium chloride, 1-ethyl-3-methylimidazolium hexafluorophosphate, 1-ethyl-3-methylimidazolium iodide, 1-ethyl-2,3,-dimethylimidazolium chloride, 1-methylimidazolium chloride, 1,2,3-trimethylimidazolium methyl sulfate, 1-methyl-3-(3,3,4,4,5,5,6,6,7,7,8,8,8-tridecafluorooctyl)-imidazolium hexafluorophosphate, 1-aryl-3-methylimidazolium chloride, 1-benzyl-3-methylimidazolium chloride, l-benzyl-3-methylimidazolium hexafluorophosphate, and 1-benzyl-3-methylimidazolium tetrafluorophosphate.

Examples of the pyridinium salt include 1-butyl-3-methylpyridinium bromide, 1-butyl-4-methylpyridinium bromide, 1-butyl-4-methylpyridinium chloride, I-butylpyridinium bromide, 1-butlpyridinium chloride, 1-butylpyridinium hexafluorophosphate, 1-ethylpyridinium bromide, and 1-ethylpyridinium chloride.

Examples of the alkyl ammonium salt include cyclohexyl trimethyl ammonium bis(trifluoromethylsulfonyl)imide, tetra-n-butyl ammonium chloride, tetrabutyl ammonium bromide, tributyl methyl ammonium methyl sulfate, tetrabutyl ammonium bis(trifluoromethylsulfonyl)imide, tetraethyl ammonium trifluoromethane sulfonate, tetrabutyl ammonium benzoate, tetrabutyl ammonium methane sulfate, tetrabutyl ammonium nonafluorobutane sulfonate, tetra-n-butyl ammonium hexafluorophosphate, tetrabutyl ammonium trifluoroacetate, tetrahexyl ammonium tetrafluoroborate, tetrahexyl ammonium bromide, tetrahexyl ammonium iodide, tetraoctyl ammonium chloride, tetraoctyl ammonium bromide, tetraheptyl ammonium bromide, tetrapentyl ammonium bromide, n-hexadecyl trimethyl ammonium hexafluorophosphate.

Examples of the alkyl pyrrolidinium salt include 1-butyl-3-methyl pyrrolidinium bromide, 1-butyl-1-methyl pyrrolidinium chloride, and 1-butyl-1-methyl pyrrolidinium tetrafluoroborate.

Examples of the alkyl phosphonium salt include tetrabutyl phosphonium bromide, tetrabutyl phosphonium chloride, tetrabutyl phosphonium tetrafluoroborate, tetrabutyl phosphonium methane sulfonate, tetrabutyl phosphonium p-toluene sulfonate, and tributyl hexadecyl phosphonium bromide.

As the ionic compound, a nitrogen-containing onium salt, a sulfur-containing onium salt, or a phosphorus-containing onium salt can be used.

Specific examples thereof include 1-butyl pyridinium tetrafluoroborate, 1-butyl pyridinium hexafluorophosphate, 1-butyl-3-methylpyridinium tetrafluoroborate, 1-butyl-3-methyl pyridinium trifluoromethane sulfonate, 1-butyl-3-methyl pyridinium bis(trifluoromethanesulfonyl)imide, 1-butyl-3-methylpyridinium bis(pentafluoroethanesulfonyl)imide, 1-hexyl pyridinium tetrafluoroborate, 2-methyl-1-pyrroline tetrafluoroborate, 1-ethyl-2-phenyl indole tetrafluoroborate, 1,2-dimethyl indole tetrafluoroborate, 1-ethyl carbazole tetrafluoroborate, 1-ethyl-3-methylimidazolium tetrafluoroborate, 1-ethyl-3-methylimidazolium acetate, 1-ethyl-3-methylimidazolium trifluoroacetate, 1-ethyl-3-methylimidazolium heptafluorobutyrate, 1-ethyl-3-methylimidazolium trifluoromethanesulfonate, 1-ethyl-3-methylimidazolium perfluorobutane sulfonate, 1-ethyl-3-methylimidazolium dicyanamide, 1-ethyl-3-methylimidazolium bis(trifluoromethanesulfonyl)imide, 1-ethyl-3-methylimidazolium bis(pentafluoroethanesulfonyl)imide, 1-ethyl-3-methylimidazolium tris(trifluoromethanesulfonyl)imide, 1-butyl-3-methylimidazolium tetrafluoroborate, 1-butyl-3-methylimidazolium hexafluorophosphate, 1-butyl-3-methylimidazolium trifluoroacetate, 1-butyl-3-methylimidazolium heptafluorobutyrate, 1-butyl-3-methylimnidazolium trifluoromethane sulfonate, 1-butyl-3-methylimidazolium perfluorobutane sulfonate, 1-butyl-3-methylimidazolium bis(trifluoromethanesulfonyl)imide, 1-hexyl-3-methylimidazolium bromide, 1-hexyl-3-methylimidazolium chloride, 1-hexyl-3-methylimidazolium tetrafluoroborate, 1-hexyl-3-methylimidazolium hexafluorophosphate, 1-hexyl-3-methylimidazolium trifluoromethane sulfonate, 1-octyl-3-methylimidazolium tetrafluoroborate, 1-octyl-3-methylimidazolium hexafluorophosphate, 1-hexyl-2,3-dimethylimnidazolium tetrafluoroborate, 1,2-dimethyl-3-propylimidazolium bis(trifluoromethanesulfonyl)imide 1-methyl pyrazolium tetrafluoroborate, 3-methyl pyrazolium tetrafluoroborate, tetrahexyl ammonium bis(trifluoromethanesulfonyl)imide, diallyl dimethyl ammonium tetrafluoroborate, diallyl dimethyl ammonium trifluoromethane sulfonate, diallyl dimethyl ammonium bis(trifluoromethanesulfonyl)imide, diallyl dimethyl ammonium bis(pentafluoroethanesulfonyl)imide, N,N-diethyl-N-methyl-N-(2-methoxyethyl)ammonium tetrafluoroborate, N,N-diethyl-N-methyl-N-(2-methoxyethyl)ammonium trifluoromethane sulfonate, N,N-diethyl-N-methyl-N-(2-methoxyethyl)ammonium bis(trifluoromethanesulfonyl)imide, N,N-diethyl-N-methyl-N-(2-methoxyethyl)ammonium bis(pentafluoroethanesulfonyl)imide, glycidyl trimethyl ammonium trifluoromethane sulfonate, glycidyl trimethyl ammonium bis(trifluoromethanesulfonyl)imide, glycidyl trimethyl ammonium bis(pentafluoroethanesulfonyl)imide, 1-butylpyridinium(trifluoromethanesulfonyl)trifluoroacetamide, 1-butyl-3-methylpyridinium(trifluoromethanesulfonyl)trifluoroacetamide, 1-ethyl-3-methylimidazolium(trifluoromethanesulfonyl)trifluoroacetamide, diallyl dimethyl ammonium(trifluoromethanesulfonyl)trifluoroacetamide, glycidyl trimethyl ammonium(trifluoromethanesulfonyl)trifluoroacetamide, N,N-dimethyl-N-ethyl-N-propylammionium bis(trifluoromethanesulfonyl)imide, N,N-dimethyl-N-ethyl-N-butylammonium bis(trifluoromethanesulfonyl)imide, N,N-dimethyl-N-ethyl-N-pentylammonium bis(trifluoromethanesulfonyl)imide, N,N-dimethyl-N-ethyl-N-hexyl ammonium bis(trifluoromethanesulfonyl)imide, N,N-dimethyl-N-ethyl-N-heptylammonium bis(trifluoromethanesulfonyl)imide, N,N-dimethyl-N-ethyl-N-nonylammonium bis(trifluoromethanesulfonyl)imide, N,N-dimethyl-N,N-dipropylammonium bis(trifluoromethanesulfonyl)imide, N,N-dimethyl-N-propyl-N-butylammonium bis(trifluoromethanesulfonyl)imide, N,N-dimethyl-N-propyl-N-pentylammonium bis(trifluoromethanesulfonyl)imide, N,N-dimethyl-N-propyl-N-hexylammonium bis(trifluoromethanesulfonyl)imide, N,N-dimethyl-N-propyl-N-heptylammonium bis(trifluoromethanesulfonyl)imide, N,N-dimethyl-N-butyl-N-hexylammonium bis(trifluoromethanesulfonyl)imide, N—N-dimethyl-N-butyl-N-heptylammonium bis(trifluoromethanesulfonyl)imide, N,N-dimethyl-N-pentyl-N-hexylammonium bis(trifluoromethanesulfonyl)imide, N,N-dimethyl-N,N-dihexylammonium bis(trifluoromethanesulfonyl)imide, trimethyl heptyl ammonium bis(trifluoromethanesulfonyl)imide, N,N-diethyl-N-methyl-N-propylammonium bis(trifluoromethanesulfonyl)imide, N,N-diethyl-N-methyl-N-pentylammonium bis(trifluoromethanesulfonyl)imide, N,N-diethyl-N-methyl-N-heptylammonium bis(trifluoromethanesulfonyl)imide, N,N-diethyl-N-propyl-N-pentylammonium bis(trifluoromethanesulfonyl)imide, triethyl propyl ammonium bis(trifluoromethanesulfonyl)imide, triethyl pentyl ammonium bis(trifluoromethanesulfonyl)imide, triethyl heptyl ammonium bis(trifluoromethanesulfonyl)imide, N,N-dipropyl-N-methyl-N-ethylammonium bis(trifluoromethanesulfonyl)imide, N,N-dipropyl-N-methyl-N-pentylammonium bis(trifluoromethanesulfonyl)imide, N,N-dipropyl-N-butyl-N-hexylammonium bis(trifluoromethanesulfonyl)imide, N,N-dipropyl-N,N-dihexylammonium bis(trifluoromethanesulfonyl)imide, N,N-dibutyl-N-methyl-N-pentylammonium bis(trifluoromethanesulfonyl)imide, N,N-dibutyl-N-methyl-N-hexylammonium bis(trifluoromethanesulfonyl)imide, trioctyl methyl ammonium bis(trifluoromethanesulfonyl)imide, and N-methyl-N-ethyl-N-propyl-N-pentylammonium bis(trifluoromethanesulfonyl)imide.

The amount of the ionic compound to be added is preferably in a range of 0.01% to 10;% by mass, more preferably in a range of 0.1% to 5% by mass, and still more preferably in a range of 0.5% to 2% by mass With respect to the total mass of the layer containing an antistatic agent. In a case where the amount thereof is in the above-described range, both of antistatic properties and adherend staining properties can be achieved.

Crosslinking Agent

As a crosslinking agent used in the present invention, an isocyanate compound, an epoxy compound, a melamine-based resin, an aziridine derivative, a metal chelate compound, or the like may be used, and it is particularly preferable to use an isocyanate compound. Further, these compounds may be used alone or in combination of two or more kinds thereof.

<Humidity Dependence of Retardation>

In the laminate according to the present invention, a humidity dependence (ΔRth (pol)) of Rth of the transparent layer in a laminate state is acquired by separating the retardation of each layer using AxoScan (manufactured by Axometrics Inc.).

A humidity dependence (ΔRth (pol)) of Rth of the transparent layer in the laminate state used for the laminate according to the present invention is preferably in a range of −20 to 20 nm, more preferably in a range of −15 to 15 nm, still more preferably in a range of −10 to 10 nm, and most preferably in a range of −5 to 5 nm.

In the present specification, ΔRth (pol) is calculated from a retardation value Re (H %) in an in-plane direction and a retardation value Rth (H %) in a thickness direction under the condition of a relative humidity of H (unit: %) using the following equation.

ΔRth(pol)=Rth(pol,30%)−Rth(pol,80%)

Rth (pol, H %) is a value obtained by adjusting the humidity of the laminate under a temperature condition of 25° C. at a relative humidity of H % for 72 hours, measuring each retardation value at a relative humidity of H %, and performing calculation. Further, in a case where it is only described as Re (pol) without specifying the relative humidity, Rth is a value measured in the same environment after the laminate stands at a relative humidity of 60% for 72 hours. In addition, Rth is a value at a wavelength of 590 nm unless otherwise noted.

(Liquid Crystal Display Device)

The liquid crystal display device of the present invention includes a liquid crystal cell and the laminate of the present invention.

The liquid crystal display device of the present invention can be suitably used in a case where the transparent layer is disposed inside (in other words, between the polarizing layer and the liquid crystal cell) or outside (in other words, the surface on a side opposite to the surface on a liquid crystal cell side) of the polarizing layer. In the liquid crystal display device of the present invention, it is preferable that the transparent layer is disposed between the polarizing layer and the liquid crystal cell.

It is preferable that the liquid crystal display device of the present invention includes a backlight and the laminate is disposed on a backlight side or on a viewing side. The backlight is not particularly limited, and known backlights can be used. It is preferable that the liquid crystal display device of the present invention is obtained by laminating the backlight, a backlight-side laminate, the liquid crystal cell, and a viewing side laminate in this order.

As for other configurations, any configurations of known liquid crystal display devices can also be employed. The system (mode) of the liquid crystal cell is not particularly limited, and the liquid crystal display device can be configured as any of liquid crystal display devices having various display systems such as a twisted nematic (TN) liquid crystal cell, a horizontal field switching in-plane switching (IPS) liquid crystal cell, a ferroelectric liquid crystal (FLC) liquid crystal cell, an anti-ferroelectric liquid crystal (AFLC) liquid crystal cell, an optically compensatory bend (OCB) liquid crystal cell, a supper twisted nematic (STN) liquid crystal cell, a vertically aligned (VA) liquid crystal cell, and a hybrid aligned nematic (HAN) liquid crystal cell. Among these, in the liquid crystal display device of the present invention, an IPS liquid crystal cell is preferable.

As other configurations, any known configurations of liquid crystal display devices can also be employed.

### Examples

Hereinafter, the present invention will be described in more detail with reference to examples. The materials, the use amounts, the ratios, the treatment contents, and the treatment procedures shown in the examples described below can be changed as appropriate within the range not departing from the gist of the present invention. Therefore, the scope of the present invention is not limited to the specific examples shown below.

<<1>> Production and Evaluation of Transparent Layer

The following materials were used.

1) Resin

Resin 1:

Commercially available polystyrene (SGP-10, manufactured by PS Japan Corporation, Tg of 100° C.) was purchased and then used as it was.

Resin 2:

Commercially available polystyrene (679, manufactured by PS Japan Corporation) was purchased and then used as it was.

Resin 3:

A commercially available cyclic olefin-based resin (ARTON RX4500, manufactured by JSR CORPORATION) was heated to 110° C. and then used after the temperature thereof was returned to room temperature.

Resin 4:

Cellulose acetate powder having a degree of substitution of 2.86 was used. The viscosity average polymerization degree of a resin 4 was 300, the degree of substitution of an acetyl group at a 6-position was 0.89, the acetone extract content was 7% by mass, the ratio of the mass average molecular weight to the number average molecular weight was 2.3, the moisture content was 0.2% by mass, the viscosity in a 6 mass % dichloromethane solution was 305 mPa·s, the amount of residual acetic acid was 0.1% by mass, the Ca content was 65 ppm, the Mg content was 26 ppm, the iron content was 0.8 ppm, the sulfate ion content was 18 ppm, the yellow index was 1.9, and the amount of free acetic acid was 47 ppm. The average particle size of the powder was 1.5 mm and the standard deviation was 0.5 mm.

2) Additive

Additive 1:

Condensate of ethanediol/1,2-propanediol/adipic acid (molar ratio of 5/5/10), number average molecular weight of 1000, hydroxyl value of 112 mgKOH/g

Additive 2:

Acetic acid ester form in both terminals of condensate of ethanediol/phthalic acid (molar ratio of 1/1), number average molecular weight of 1000, hydroxyl value of 0 mgKOH/g

Antistatic Agent 1:

1-butyl-3-methylpyridinium bis(trifluoromethanesulfonyl)imide

Surfactant 1: A surfactant having the following structure was used.

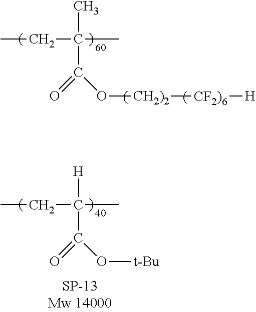

3) Release Film

Base Material 1:

A polyethylene terephthalate film (film thickness of 38 μm) in which one surface was subjected to a mat treatment and the other surface was not subjected to a surface treatment was prepared and then used as a base material 1.

Base Material 2:

A commercially available polyethylene terephthalate film LUMIRROR® S105 (film thickness of 38 μm, manufactured by TORAY INDUSTRIES, INC.) was used as a base material 2.

Base Material 3:

A commercially available polyethylene terephthalate film LUMIRROR® S10 (film thickness of 25 μm, manufactured by TORAY INDUSTRIES, INC.) was used as a base material 3.

<Transparent Layer 1>

(Preparation of Resin Solution)

20 parts by mass of the resin 1 and an ethyl acetate solvent having a moisture absorptivity of 0.2% by mass or less were stirred in a mixing tank for dissolution, thereby obtaining a resin solution having a concentration of solid contents of 9% by mass.

Further, solvents used for transparent layers 2 to 9 described below respectively have a moisture absorptivity of 0.2% by mass or less.

Next, the obtained solution was filtered using filter paper (#63, manufactured by Toyo Roshi Kasha, Ltd.) having an absolute filtration accuracy of 10 μm and further filtered using a metal sintered filter (FH025, manufactured by Pall Corporation) having an absolute filtration accuracy of 2.5 μm, thereby obtaining a resin solution 1.

(Preparation of Transparent Layer)

The surface of the base material 1, which had not been subjected to a surface treatment, was continuously coated with the resin solution 1 using a bar coater such that the thickness of the dried layer was set to the value listed in Table 1 and dried at 100° C., and a transparent layer 1 was formed on polyethylene terephthalate.

<Transparent Layer 2>

A transparent layer 2 was obtained in the same manner as that for the transparent layer 1 except that the following material group was used in place of 20 parts by mass of the resin 1.

| | | |
|---|---|---|
| Resin 1 | 17 | parts by mass |
| Resin 2 | 3 | parts by mass |

<Transparent Layer 3>

A transparent layer 3 was obtained in the same manner as that for the transparent layer 1 except that the resin 1 was changed to the resin 3 and the ethyl acetate solvent was changed to a toluene solvent.

<Transparent Layer 4>

A laminate was obtained by forming the transparent layer 1 having a thickness of 2 μm on a surface of the transparent layer 3, prepared according to the above-described method, which was not in contact with the base material 1. The laminate of the transparent layer 3 and the transparent layer 1 was set as a transparent layer 4.

<Transparent Layer 5>

A transparent layer 5 was obtained in the same manner as that for the transparent layer 1 except that the following material group was used in place of 20 parts by mass of the resin 1, the ethyl acetate solvent was changed to a dichloromethane solvent, and the concentration of solid contents was changed from 9% by mass to 5% by mass.

| | | |
|---|---|---|
| Resin 4 | 20 | parts by mass |
| Additive 1 | 3 | parts by mass |

<Transparent Layer 6>

A transparent layer 6 was obtained in the same manner as that for the transparent layer 1 except that the following material group was used in place of 20 parts by mass of the resin 1, the thickness of the dried layer was set to the thickness listed in Table 1, and the drying temperature was set to 110° C.

| | | |
|---|---|---|
| Resin 1 | 20 | parts by mass |
| Surfactant 1 | 0.02 | parts by mass |

<Transparent Layer 7>

A transparent layer 7 was obtained in the same manner as that for the transparent layer 1 except that the following material group was used in place of 20 parts by mass of the resin 1, and the thickness of the dried layer was set to the thickness listed in Table 1.

| | | |
|---|---|---|
| Resin 1 | 18 | parts by mass |
| Additive 2 | 2 | parts by mass |

<Transparent Layer 8>

A transparent layer 8 was obtained in the same manner as that for the transparent layer 1 except that the base material 1 was changed to the base material 2 and the thickness of the dried layer was set to the thickness listed in Table 1.

<Transparent Layer 9>

A transparent layer 9 was obtained in the same manner as that for the transparent layer 1 except that the base material 1 was changed to the base material 3 and the thickness of the dried layer was set to the thickness listed in Table 1.

<Transparent Layer 10>

The following material group was used in place of 20 parts by mass of the resin 1, a surface of the base material 1 which had not been subjected to the surface treatment was continuously coated with the resin solution using a die coater such that the thickness of the dried layer was set to the thickness listed in Table 1, the solution was dried at 60° C. so that a coated layer was formed on polyethylene terephthalate, the coated layer was irradiated with ultraviolet rays with an illuminance of 200 mW/cm² and an irradiation dose of 100 mJ/cm² using a 160 W/cm air-cooled metal halide lamp (manufactured by EYE GRAPHICS CO., LTD.) having an oxygen concentration of approximately 0.01% by volume in a nitrogen purge so that the coated layer was cured, thereby forming a transparent layer 10.

| | | |
|---|---|---|
| CELLOXIDE 2021P [manufactured by | 48 | parts by mass |
| DAICEL CORPORATION] | | |
| CPI 100P [manufactured by San-Apro Ltd.] | 2 | parts by mass |

<Film 1>

A commercially available polyethylene terephthalate film (film thickness of 80 μm, manufactured by Fujifilm Corporation) having one surface on which an easily adhesive layer had been formed was used as it was.

(Evaluation of Transparent Layer)

The transparent layer prepared in the above-described manner was evaluated according to the above-described method, and the results are listed in Table 1.

TABLE 1

| | | | Moisture | | |
|---|---|---|---|---|---|
| | | Equilibrium | permeability | | |
| | Thick- | moisture | in terms | | |
| | ness | absorptivity | of 5 μm | Re | Rth |
| | [μm] | [wt %] | [g/m²/day] | [nm] | [nm] |
| Transparent layer 1 | 3.0 | 0.03 | 930 | 0.2 | −3 |
| Transparent layer 2 | 3.0 | 0.04 | 960 | 0.1 | −4 |
| Transparent layer 3 | 3.0 | 0.10 | 480 | 0.6 | 2 |
| Transparent layer 4 | 5.0 | 0.10 | 500 | 0.3 | 0 |
| Transparent layer 5 | 3.0 | 3.30 | 7000 | 0.8 | −1 |
| Transparent layer 6 | 5.0 | 0.03 | 930 | 0.2 | −4 |
| Transparent layer 7 | 5.0 | 0.03 | 940 | 0.3 | −3 |
| Transparent layer 8 | 5.0 | 0.03 | 930 | 0.1 | −3 |
| Transparent layer 9 | 5.0 | 0.03 | 930 | 0.2 | −3 |
| Transparent layer 10 | 5.0 | 1.60 | 820 | 1.1 | −4 |
| Film 1 | 80 | 0.50 | 190 | — | — |

<<2>> Preparation and Evaluation of Laminate

(Preparation of Laminate)

1) Surface Treatment on Transparent Layers 1 to 5 and Film 1

A corona treatment was performed on the surface of each of the transparent layers 1 to 5 on the opposite side of the polyethylene terephthalate base material to prepare transparent layers 1 to 5 on which the surface treatment had been performed. Further, the surface of the easily adhesive layer in the film 1 was subjected to a corona treatment, thereby preparing a film 1 on which the surface treatment had been performed.

Further, the transparent layers 6 to 10 were not subjected to a corona treatment and were used as they were.

Further, a cellulose acetate film (FUJITAC TG40, manufactured by Fujifilm Corporation) was immersed in 1.5 mol/L of a sodium hydroxide aqueous solution (saponification liquid), whose temperature was adjusted to 37° C., for 1 minute, washed with water, immersed in 0.05 mol/L of a sulfuric acid aqueous solution for 30 seconds, and then allowed to pass through a washing bath. Further, draining was repeated three times using an air knife, water was dropped on the resulting film, and the film was allowed to stand in a drying zone at 70° C. for 15 seconds and dried, thereby preparing a cellulose acetate film on which a saponification treatment was performed.

2) Preparation of Polarizing Layer

In the same manner as in Example 1 of JP2001-141926A, a difference in peripheral speed was provided for a space between two pairs of nip rolls so that stretching was carried out in the longitudinal direction, thereby preparing a polarizing layer with a thickness of 12 μm.

3) Adhesion

A laminate having one selected from the surface-treated transparent layers 1 to 5, the surface-treated film 1, and the transparent layers 6 to 10 on one surface of the polarizing layer and the saponified cellulose acetate film on the other surface of the polarizing layer was prepared. More specifically, the polarizing layer was interposed between the saponified cellulose acetate film (hereinafter, such a film is referred to as a “protective film”) and one selected from the surface-treated transparent layers 1 to 5, the surface-treated film 1, and the transparent layers 6 to 10 listed in Table 2, and the layers were laminated such that an absorption axis of the polarizing layer was in parallel with the longitudinal direction of the protective film according to a roll-to-roll system using the following adhesive listed in Table 2.

Here, at the time of adhesion of the protective film to the polarizing layer, the surface-treated transparent layers 1 to 5 and the surface-treated film 1 were set such that the corona-treated surface was disposed on the polarizing layer side, and the transparent layers 6 to 10 were set such that the surface on the opposite side of the polyethylene terephthalate base material was disposed on the polarizing layer side.

Adhesive 1: A 3% aqueous solution in polyvinyl alcohol (PVA-117H, manufactured by Kuraray Co., Ltd.) was used as an adhesive.

Adhesive 2: An adhesive was prepared in conformity with the adhesive A described in Example 1 of JP2009-294502A.

Next, polyethylene terephthalate serving as a base material of the transparent layers 1 to 10 was continuously peeled off using the same device as the peeling device of a separator after being dried at 70° C. At this time, the transparent layer 7 had a moderately high force required for peeling compared to other transparent layers, and the release film was able to be stably peeled off.

Subsequently, the transparent layer or the film 1 was coated with a pressure sensitive adhesive containing 2% by mass of the antistatic agent 1 and butyl acrylate as the base material, thereby preparing laminates 1 to 11.

A laminate 12 in which the transparent layer 6 was formed on both surfaces of the polarizing layer was prepared in the same manner as that for the laminate 7 except that the cellulose acetate film in the laminate 7 obtained by using the transparent layer 6 as one protective film and the cellulose acetate film as the other protective film was changed to the transparent layer 6. It was confirmed that the initial degree of polarization of this laminate was 99.9% or greater.

(Evaluation of Laminate)

The laminate was punched using a Thomson blade having a size of 40 mm×40 mm and was allowed to adhere to a non-alkali glass plate having a thickness of 1 mm and a size of 50 mm×50 mm through the pressure sensitive adhesive surface.

1) Initial Degree of Polarization

The degree of polarization of the laminate adhered to the glass plate was calculated according to the above-described method, the degree of polarization of the entire laminate was 99.9% or greater. The degree of polarization was measured using an automatic polarizing film measuring device VAP-7070 (manufactured by JASCO Corporation).

2) Degree of Polarization with Time

The test piece whose initial degree of polarization was measured was held in an environment of 85° C. at a relative humidity of 85% for 3 days, and further held in an environment of 25° C. at a relative humidity of 60% for 24 hours, and the degree of polarization was measured according to the above-described method. This degree of polarization was set as a degree of polarization with time.

3) Transition Ratio of Antistatic Agent

The sample whose initial degree of polarization was measured was held in an environment of 85° C. at a relative humidity of 85% for 3 days, and further held in an environment of 25° C. at a relative humidity of 60% for 24 hours, and the transition ratio of the antistatic agent was measured according to the above-described method. The results are listed in Table 2.

4) Adhesiveness of Polarizing Layer

The evaluation was performed according to a crosscut method described in JIS-K-5600-5-6-1. 100 squares were formed in a grid form on the surface of a transparent layer of the prepared laminate at intervals of 1 mm, and an adhesion test was performed using cellophane tape (registered trademark) (manufactured by NICHIBAN CO., LTD.). New cellophane tape was attached thereto and then peeled off, and then evaluation was performed based on the following standard.

A: The squares in the grid form were not peeled off.

B: The squares in the grid form were not peeled off at a percentage of 50% or greater and less than 100%.

C: The squares in the grid form were not peeled off at a percentage of less than 50%.

The standards A and B are in levels indicating that there are no practical problems, and the standard A is preferable.

5) Evaluation of Mounting Laminate on Liquid Crystal Display Device (Mounting Laminate on IPS Type Liquid Crystal Display Device)

The prepared laminate described above was allowed to adhere to a liquid crystal cell through a pressure sensitive adhesive such that the prepared transparent layer side was disposed on the liquid crystal cell side, in place of a rear-side polarizing plate of an IPS mode liquid crystal television (slim type 55 type liquid crystal television, the clearance between the backlight and the liquid crystal cell was 0.5 mm). The obtained liquid crystal television was transferred to an environment at 25° C. and a relative humidity of 60% after being held in an environment of 50° C. at a relative humidity of 80% for 3 days, continuously lighted up in a black display state, and visually observed after 48 hours, and the light unevenness was evaluated.

(Light Unevenness Level in Front Direction after Durability Test)

The light unevenness (in other words, luminance unevenness) was observed at the time of black display in a case where the device was observed from the front side, and the evaluation was performed based on the following standards.

AA: Unevenness was unlikely to be visually recognized in an environment of an illuminance of 20 lx.

A: Unevenness was unlikely to be visually recognized in an environment of an illuminance of 100 lx.

B: Light unevenness was visually recognized in an environment of an illuminance of 100 lx.

C: Clear unevenness was visually recognized in an environment of an illuminance of 100 lx.

D: Clear unevenness was visually recognized in an environment of an illuminance of 300 lx.

The standards AA, A, and B are in levels indicating that there are no practical problems, and the standards AA and A are preferable. Further, severe light unevenness occurred on the entire surface of the liquid crystal display device of Comparative Example 2 obtained by using the laminate 6, and as the result, the above-described evaluation was not able to be performed. Further, peeling was visually observed from the peripheral portion of the laminate.

TABLE 2

| | | Transparent | | Transition ratio of | Degree of polarization | Adhesiveness of | Evaluation of |
|---|---|---|---|---|---|---|---|
| | Laminate | layer/Film | Adhesive | antistatic agent [%] | with time [%] | polarizing layer | mounting |
| Example 1 | Laminate 1 | Transparent | 1 | 2.3 | 99.9 | A | AA |
| | | layer 1 | | | | | |
| Example 2 | Laminate 2 | Transparent | 1 | 5.0 | 99.9 | A | AA |
| | | layer 2 | | | | | |
| Example 3 | Laminate 3 | Transparent | 1 | 1.6 | 99.9 | B | AA |
| | | layer 3 | | | | | |
| Example 4 | Laminate 4 | Transparent | 1 | 0.8 | 99.9 | A | AA |
| | | layer 4 | | | | | |
| Comparative | Laminate 5 | Transparent | 1 | 50.0 | 86.5 | A | A |
| Example 1 | | layer 5 | | | | | |
| Comparative | Laminate 6 | Film 1 | 2 | 0.0 | 99.9 | Impossible to | Impossible to |
| Example 2 | | | | | | evaluate | evaluate |
| Example 5 | Laminate 7 | Transparent | 2 | 0.4 | 99.9 | A | AA |
| | | layer 6 | | | | | |
| Example 6 | Laminate 8 | Transparent | 2 | 0.2 | 99.9 | A | AA |
| | | layer 7 | | | | | |
| Example 7 | Laminate 9 | Transparent | 2 | 0.6 | 99.9 | A | AA |
| | | layer 8 | | | | | |
| Example 8 | Laminate 10 | Transparent | 2 | 0.4 | 99.9 | A | AA |
| | | layer 9 | | | | | |
| Example 9 | Laminate 11 | Transparent | 1 | 28.0 | 97.0 | B | C |
| | | layer 10 | | | | | |
| Example 10 | Laminate 12 | Transparent | 2 | 0.4 | 99.9 | A | AA |
| | | layer 6 | | | | | |

As listed in Table 2, it was understood that the laminate of the present invention had excellent reliability in a case of being held in a moisture-heat environment and was able to suppress light unevenness of the liquid crystal display device accompanied by the environment change in a case of being mounted on the liquid crystal display device.

According to the present invention, it is possible to provide a laminate, with a high yield, which has excellent reliability and is capable of suppressing light unevenness of a liquid crystal display device which is accompanied by environmental change in a case of being mounted on the liquid crystal display device. Further, it is possible to provide a liquid crystal display device, with a high yield, which is obtained by using this laminate, is unlikely to generate light unevenness, and has excellent reliability.

The present invention has been described in detail with reference to the specific embodiments, but it will be apparent to those skilled in the art that various changes and modifications can be made without departing from the spirit and the scope of the present invention.

This application is based on Japanese Patent Application (JP2016-020717) filed on Feb. 5, 2016, Japanese Patent Application (JP2016-108701) filed on May 31, 2016, and Japanese Patent Application (JP2016-250983) filed on Dec. 26, 2016, the contents of which are incorporated herein by reference.

What is claimed is:

1. A laminate comprising at least:
a polarizing layer;
an adhesive layer;
a transparent layer; and
a layer which contains an antistatic agent, in this order,
wherein a thickness of the transparent layer is in a range of 0.1 to 10 μm, and
a transition ratio of the antistatic agent after high temperature and high humidity test is in a range of 0% to 30%.

2. The laminate according to claim 1,
wherein the transition ratio of the antistatic agent after high temperature and high humidity test is in a range of 0.01% to 30%.

3. The laminate according to claim 1,
wherein an equilibrium moisture absorptivity of the transparent layer is 2.0% by mass or less.

4. The laminate according to claim 1,
wherein a moisture permeability of the transparent layer in terms of 5 μm is in a range of 200 to 5000 g/m²/day.

5. The laminate according to claim 1,
wherein the transparent layer contains at least one of a fluorine-based compound and a silicon-based compound.

6. The laminate according to claim 1,
wherein the transparent layer contains a styrene-based resin.

7. The laminate according to claim 1,
wherein an in-plane retardation Re of the transparent layer at a wavelength of 590 nm is in a range of 0 to 20 nm, and
a thickness direction retardation Rth of the transparent layer at a wavelength of 590 nm is in a range of −25 to 25 nm.

8. The laminate according to claim 1,
wherein the transparent layer is formed of two or more layers.

9. The laminate according to claim 1,
wherein the antistatic agent contains an organic cationic compound.

10. The laminate according to claim 1,
wherein a content of the antistatic agent is in a range of 0.01% to 10% by mass with respect to a content of a composition of the layer containing the antistatic agent.

11. The laminate according to claim 1,
wherein the polarizing layer contains an iodine-polyvinyl alcohol complex.

12. A liquid crystal display device comprising:
a liquid crystal cell; and
the laminate according to claim 1.

13. The liquid crystal display device according to claim 12,
wherein the transparent layer is disposed between the polarizing layer and the liquid crystal cell.

14. The liquid crystal display device according to claim 12, further comprising:
a backlight,
wherein the backlight, the laminate and the liquid crystal cell are disposed in this order.

15. The liquid crystal display device according to claim 12, further comprising:
a backlight,
wherein the backlight, the liquid crystal cell and the laminate are disposed in this order.

16. The liquid crystal display device according to claim 12,
wherein the liquid crystal cell is of an in-plane switching system.

17. A laminate comprising at least:
a polarizing layer;
an adhesive layer;
a transparent layer; and
a layer which contains an antistatic agent, in this order,
wherein a thickness of the transparent layer is in a range of 0.1 to 10 μm,
an equilibrium moisture absorptivity of the transparent layer is 2.0% by mass or less,
a moisture permeability of the transparent layer in terms of 5 μm is in a range of 200 to 5000 g/m²/day, and
the antistatic agent contains an organic cationic compound.
